(19) United States
(12) Patent Application Publication
(10) Pub. No.: US 2025/0232130 A1
(43) Pub. Date: Jul. 17, 2025

(54) DYNAMIC RECONFIGURATION OF DASHBOARD CONTENT BASED ON CALL PROGRESS

(71) Applicant: The Toronto-Dominion Bank, Toronto (CA)

(72) Inventors: Linda Ling Tao, Toronto (CA); Anand Pandey, Markham (CA); Prerak Trivedi, Mississauga (CA)

(73) Assignee: The Toronto-Dominion Bank, Toronto (CA)

(21) Appl. No.: 18/412,392

(22) Filed: Jan. 12, 2024

(51) Int. Cl. G06F 40/40; G06F 3/0482; G06Q 40/06

(52) U.S. Cl. CPC G06F 40/40; G06F 3/0482; G06Q 40/06

(57) ABSTRACT

An example operation may include one or more of identifying a first topic from a call actively in progress, displaying a dashboard on a user device on the call, wherein the dashboard comprises content related to the first topic, receiving discussion data from the call, determining that a focus of the call has shifted from the first topic to a second topic, executing an artificial intelligence (AI) model on the second topic, dynamically generating dashboard content based on the execution, and displaying the dynamically generated dashboard content to the dashboard on the user device.

### BACKGROUND

Wealth advisors work with clients to develop investment strategies, retirement plans, wealth-building plans, and the like. In many cases, an advisor will speak with clients during meetings, phone calls, teleconferences, and the like, which may utilize software that provides financial information. In many cases, the information displayed using the software is not congruous with the discussion between the client and the advisor. As such, the information being displayed may not be related to the topics of discussion.

### SUMMARY

One example embodiment provides an apparatus that may include a memory and a processor communicatively coupled to the memory, the processor configured to train an artificial intelligence (AI) model based on a plurality of dashboards related to a software application that corresponds to a plurality of topics, ingest a call transcript from a previous call with a user, generate a new topic from the call transcript; determine that the new topic is distinct from the existing plurality of topics, execute the AI model based on the new topic, generate a dashboard with content based on the execution of the AI model, and display the dashboard via the software application.

Another example embodiment provides a method that includes one or more of training an artificial intelligence (AI) model based on a plurality of dashboards related to a software application that corresponds to a plurality of topics, ingesting a call transcript from a previous call with a user, generating a new topic from the call transcript, determining that the new topic is distinct from the existing plurality of topics, executing the AI model based on the new topic, generating a dashboard with content based on the execution of the AI model, and displaying the dashboard via the software application.

A further example embodiment provides a computer-readable storage medium comprising instructions stored therein which when executed by a processor cause the processor to perform one or more of training an artificial intelligence (AI) model based on a plurality of dashboards related to a software application that corresponds to a plurality of topics, ingesting a call transcript from a previous call with a user, generating a new topic from the call transcript, determining that the new topic is distinct from the existing plurality of topics, executing the AI model based on the new topic, generating a dashboard with content based on the execution of the AI model, and displaying the dashboard via the software application.

Another example embodiment provides an apparatus that may include a memory, and a processor communicatively coupled to the memory, the processor configured to identify a first topic from a call actively in progress, display a dashboard on a user device on the call, wherein the dashboard comprises content related to the first topic, receive discussion data from the call, determine that a focus of the call has shifted from the first topic to a second topic, execute an artificial intelligence (AI) model on the second topic; dynamically generate dashboard content based on the execution, and display the dynamically generated dashboard content to the dashboard on the user device.

Another example embodiment provides a method that includes one or more of identifying a first topic from a call actively in progress, displaying a dashboard on a user device on the call, wherein the dashboard comprises content related to the first topic, receiving discussion data from the call, determining that a focus of the call has shifted from the first topic to a second topic, executing an artificial intelligence (AI) model on the second topic, dynamically generating dashboard content based on the execution, and displaying the dynamically generated dashboard content to the dashboard on the user device.

A further example embodiment provides a computer-readable storage medium comprising instructions stored therein which when executed by a processor cause the processor to perform one or more of identifying a first topic from a call actively in progress, displaying a dashboard on a user device on the call, wherein the dashboard comprises content related to the first topic, receiving discussion data from the call, determining that a focus of the call has shifted from the first topic to a second topic, executing an artificial intelligence (AI) model on the second topic, dynamically generating dashboard content based on the execution, and displaying the dynamically generated dashboard content to the dashboard on the user device.

### BRIEF DESCRIPTION OF THE DRAWINGS

FIG. 1 is a diagram illustrating an artificial intelligence (AI) computing environment for generating dashboard content according to example embodiments.

FIG. 2 is a diagram illustrating a process of executing a machine-learning model on input according to example embodiments.

FIGS. 3A-3C are diagrams illustrating processes for training a machine learning model according to example embodiments.

FIG. 4 is a diagram illustrating a process of prompting an AI model to generate graphical user interface (GUI) content according to example embodiments.

FIGS. 5A-5C are diagrams illustrating a process of dynamically generating content for a dashboard or GUI content based on call content or transcripts according to example embodiments.

FIGS. 6A-6C are diagrams illustrating a process of reconfiguring a GUI and/or dashboard based on conversation content according to example embodiments.

FIG. 7A is a flow diagram illustrating a method of dynamically generating a dashboard based on call content according to example embodiments.

FIG. 7B is a flow diagram illustrating a method of reconfiguring content on a dashboard based on conversation progress according to example embodiments.

FIG. 7C is a flow diagram according to example embodiments.

FIG. 7D is another flow diagram according to example embodiments.

FIG. 8 is a diagram illustrating a computing system that may be used in any of the example embodiments described herein.

### DETAILED DESCRIPTION

It is to be understood that although this disclosure includes a detailed description of cloud computing, implementation of the instant solution recited herein is not limited to a cloud computing environment. Rather, embodiments of the instant solution are capable of being implemented in conjunction with any other type of computing environment now known or later developed.

The example embodiments are directed to a platform that can ingest content that is going to be discussed during a meeting between devices, content that is currently being discussed during a meeting between the devices, and the like, and generate graphical user interface (GUI) content based on topics of discussion and display the GUI content during the meeting. In some embodiments, an artificial intelligence (AI) model may be trained to understand a correlation between text-based descriptions of topics and image content related to the topics. For example, the AI model may be a multimodal large language model (LLM) or the like which learns a correlation between text and images.

Technological advancements typically build upon the fundamentals of predecessor technologies, such is the case with AI models. An AI classification system describes the stages of AI progression. The first classification is known as “Reactive Machines,” followed by present-day AI classification “Limited Memory Machines” (also known as “Artificial Narrow Intelligence”), then progressing to “Theory of Mind” (also known as “Artificial General Intelligence”), and reaching the AI classification “Self Aware” (also known as “Artificial Superintelligence”). Present-day Limited Memory Machines are a growing group of AI models built upon the foundation of its predecessor, Reactive Machines. Reactive Machines emulate human responses to stimuli; however, they are limited in their capabilities as they cannot typically learn from prior experience. Once the AI model's learning abilities emerged, its classification was promoted to Limited Memory Machines. In this present-day classification, AI models learn from large volumes of data, detect patterns, solve problems, generate and predict data, and the like, while inheriting all of the capabilities of Reactive Machines. Examples of AI models classified as Limited Memory Machines include, but are not limited to, Chatbots, Virtual Assistants, Machine Learning (ML), Deep Learning (DL), Natural Language Processing (NLP), Generative AI (GenAI) models, and any future AI models that are yet to be developed possessing the characteristics of Limited Memory Machines. Generative AI models are a combination of Limited Memory Machine technologies, incorporating ML and DL, and, in turn, form the foundational building blocks of future AI models. For example, Theory of Mind is the next progression of AI that will be able to perceive, connect, and react by generating appropriate reactions in response to the entity with which the AI model is interacting; all of these capabilities rely on the fundamentals of Generative AI. Furthermore, in an evolution into the Self Aware classification, AI models will be able to understand and evoke emotions in the entities they interact with, as well as possessing their own emotions, beliefs, and needs, all of which rely on Generative AI fundamentals of learning from experiences to generate and draw conclusions about itself and its surroundings. Generative AI models are integral and core to future artificial intelligence models. As described herein, Generative AI refers to present-day Generative AI models, as well as future AI models.

For example, the AI model may be trained on a large corpus of dashboard content such as web pages with images, text-based descriptions, and the like, which are related to assets such as investment assets, income, retirement contributions, and the like. The AI model may also be trained on GUI location preferences for certain types of content, input mechanism, menus, icons on the dashboard, etc. Furthermore, the AI model may create GUI content based on the training. For example, during the training, the AI model may learn correlations between topics of discussion and display content that is related to the topics of interest. Furthermore, the AI model may also generate display content that can be output on a dashboard of the meeting application.

According to various embodiments, the AI model may be a large language model (LLM) such as a multimodal large language model. As another example, the AI model may be a transformer neural network (“transformer”), or the like. The AI model is capable of understanding connections between text and display components (e.g., boxes of content, windows of content, modules of content, etc.) within the dashboard. For example, the AI model may include libraries and deep learning frameworks that enable the AI model to create realistic display content based on text inputs. The AI model may also analyze the content from the meeting to identify correlations between other clients/meetings and build automated call lists, call scripts, and call content.

By creating software meeting content from text, the AI model can relieve a user from having to generate such content. Furthermore, the AI model can provide the content in “real-time” while the call is being performed or before the call is ever conducted thereby allowing the advisor to work on other matters while the AI model and software create content that is displayed during the meeting between the client and the advisor. Furthermore, as the meeting progresses, the AI model may listen to content (e.g., audio from the meeting) and detect that the topic has changed to a different topic of interest. In this case, the AI model may dynamically modify the dashboard based on the change in topic. As another example, the AI model can determine what is currently being discussed between the client and the advisor, and emphasize content associated therewith on the dashboard in real-time.

Additionally, the AI model can dynamically generate new GUI content and dynamically rearrange existing GUI content. The AI model can generate and output images, graphs, charts, text content, and the like, describing the current performance, the future/predicted performance, and the like, of investment assets. Furthermore, the AI model can dynamically emphasize content on the screen based on what is being discussed.

Building strong customer relationships requires being attentive to the customer's questions, goals, and progress. Following up in a timely manner, adding value, and resolving the customers' questions and needs are crucial to building long-lasting trust and increasing customer satisfaction and retention. Proactively engaging during a follow-up with additional information from inquiries, resolution to open issues, and progress against target goals all go a long way towards building a relationship with the customer. Additionally, personalized interactions and thoughtful content help avoid being generic and keep customers engaged.

Recorded meetings provide an excellent way to capture meeting details that would be difficult to do with manual notes. However, reviewing recorded meetings either by listening to them or by reading dictated notes is a very time-consuming task. This instant solution uses an AI model trained on ingested call transcripts from previous user calls to identify topics of interest from the previous calls. It then generates a dashboard of content based on the identified topics and displays the dashboard in a software application. The conversation content may be converted into a vector that can be processed by the AI model to generate an output.

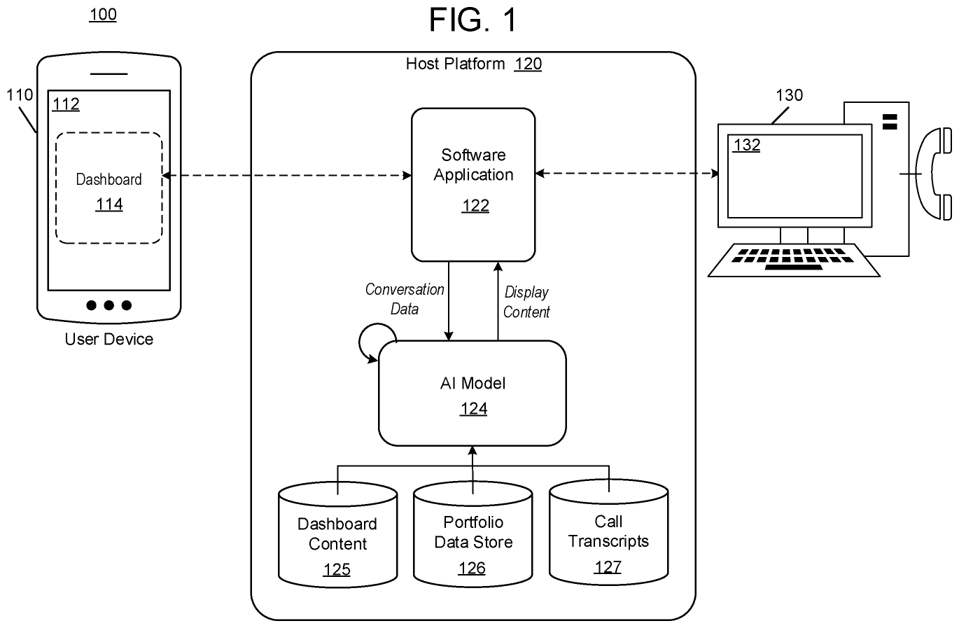

FIG. 1 illustrates an artificial intelligence (AI) computing environment 100 for generating content according to example embodiments. Referring to FIG. 1, a host platform 120, such as a cloud platform, web server, etc., may host a meeting between a user device 110 and a user device 130. Here, each of the user devices may be a mobile device, a computer, a laptop, a desktop computer, or the like. The user devices may include a display which can output visual content such as meeting content. For example, the user device 110 includes a user interface 112 for displaying meeting content. Meanwhile, the user device 130 may include a user interface 132 for displaying meeting content.

Here, the host platform 120 may host the software application 122 and make it accessible to the user device 110 and the user device 130 at the same time over a computer network such as the Internet. For example, the software application 122 may be a mobile application that includes a front-end which is installed on the user device 110 (and the user device 130) and a back-end which is installed on the host platform 120. As another example, the software application 122 may be a progressive web application (PWA) that is hosted by the host platform 120 and made accessible via a browser on the user device 110 and/or the user device 130 via an address on the web.

In the example embodiments, the host platform 120 may include one or more AI models including AI model 124 which is capable of ingesting call content including meeting notes, call transcripts, meeting summaries, live conversation, and the like, and dynamically generate GUI content based on the topics of conversation in the meeting. For example, the AI model 124 may be trained on one or more of historical dashboard content stored within a data store 125, user portfolio data stored in a data store 126, call transcripts stored in a data store 127, and the like. The host platform 120 may also include one or more additional models including one or more machine learning models, one or more AI models, one or more additional AI models, and the like. The models including the AI model 124 may be held by the host platform 120 within a model repository (not shown).

In the example embodiments, the AI model 124 may be trained based on GUI content from open sources such as publicly available sources on the web, and the like. The AI model 124 may be trained to generate visual content that can be depicted on a user interface of the meeting software. For example, the AI model 124 may be trained based on web pages that describe information about topics of interest such as investment assets, and the like, and generate GUI content corresponding to the topics of interest based on the training.

The data within the data store 125, the data store 126, and the data store 127 may be accessed via one or more application programming interfaces (APIs). Although not shown, the host platform 120 may also access one or more external systems (e.g., databases, websites, etc.)

over a computer network and collect/retrieve data from the one or more external systems including user data.

In the example of FIG. 1, the user devices 110 and 130 may exchange speech, text, images, communications, and the like, submitted through the software application 122. For example, audio may be spoken, text may be entered into a text box, documents may be viewed, and the like. The conversation between the users may be recorded by the software application 122, converted into a vector or other encoding, and submitted to the AI model 124. In response, the AI model 124 may dynamically detect topics that are being discussed during the meeting from the conversation content and dynamically generate GUI content to be displayed during the meeting.

As an example, a dashboard 114 may be generated by the AI model 124 and output by the software application 122 on the user interface 112 of the user device 110. Although not shown in FIG. 1, a dashboard may also be displayed on the user interface 132 of the user device 130. The dashboard may be the same or different.

The dashboard may include content that is visible to both of the user devices 110 and 130 and/or content that is only visible to one of the user devices. The software application 122 may control which device sees which content and create different experiences on the user interface for each of the user devices 110 and 130 during the meeting. Furthermore, the AI model 124 may ingest the content recorded from the meeting and generate additional content that can be displayed during the meeting and additional content that can be used after the meeting such as a call script, a call list, and the like. The AI model 124 may use audio from the meeting to detect when the conversation changes from one topic to another topic and modify the dashboard in response to such a change. The topics may include assets such as stocks, bonds, digital assets, cryptocurrency, and other investment vehicles, but embodiments are not limited thereto.

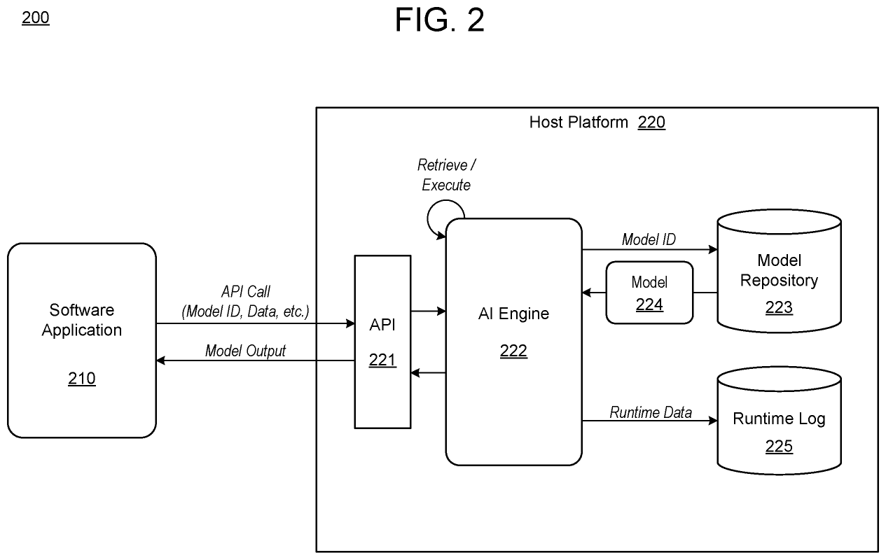

FIG. 2 illustrates a process 200 of executing a model 224 on input content according to example embodiments. As an example, the model 224 may be the AI model 124 described with respect to FIG. 1, however, embodiments are not limited thereto. Referring to FIG. 2, a software application 210 may request execution of the model 224 by submitting a request to the host platform 220. For example, the request may include an API invocation or other submission identifiers of model data such as an identifier of the model to be executed, a payload of data to be input to the model during execution, an expected output, a storage location for the expected output, and the like. In response, an AI engine 222 may receive the request, retrieve the model 224 from a model repository 223, and trigger the model 224 to execute within a runtime environment of the host platform 220.

In FIG. 2, the AI engine 222 may control access to models that are stored within the model repository 223. For example, the models may include AI models, generative AI models, machine learning models, neural networks, and/or the like. The software application 210 may trigger execution of the model 224 from the model repository 223 via invocation of an API 221 of the AI engine 222. The invocation may include an identifier of the model 224 such as a unique identifier assigned by the host platform 220, a payload of data (e.g., to be input to the model during execution), and the like. The AI engine 222 may retrieve the model 224 from the model repository 223 in response to the invocation and deploy the model 224 within a live runtime environment. After the model is deployed, the AI engine 222 may execute the running instance of the model 224 on the payload of data and return a result of the execution to the software application 210.

In some embodiments, the payload of data may be in a format that cannot be input to the model 224 nor read by a computer processor. For example, the payload of data may be in text format, image format, audio format, and the like. In response, the AI engine 222 may convert the payload of data into a format that is readable by the model 224 such as a vector or other encoding. The vector may then be input to the model 224.

In some embodiments, the software application 210 may display a user interface which enables a user thereof to provide feedback regarding the output provided by the model 224. For example, a user may input a confirmation that the asset of interest generated by an AI model is correct or is relevant. This information may be added to the results of the execution and stored within a log 225. The log 225 may include an identifier of the input, an identifier of the output, an identifier of the model executed, and feedback from the recipient. This information may be used to subsequently retrain the model.

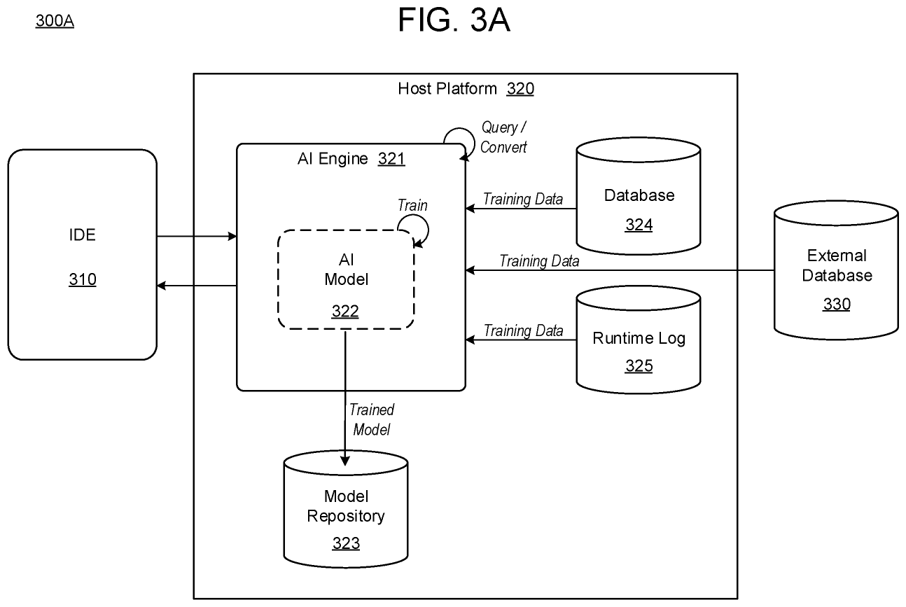

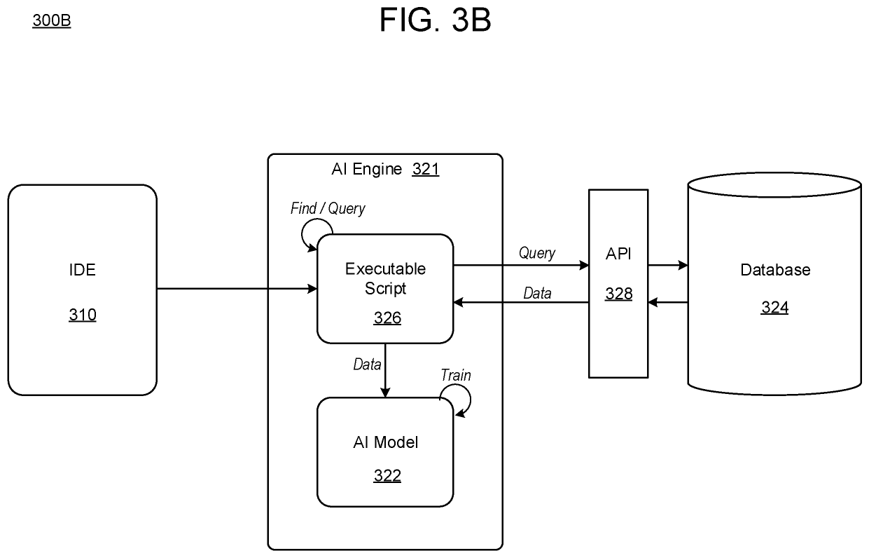

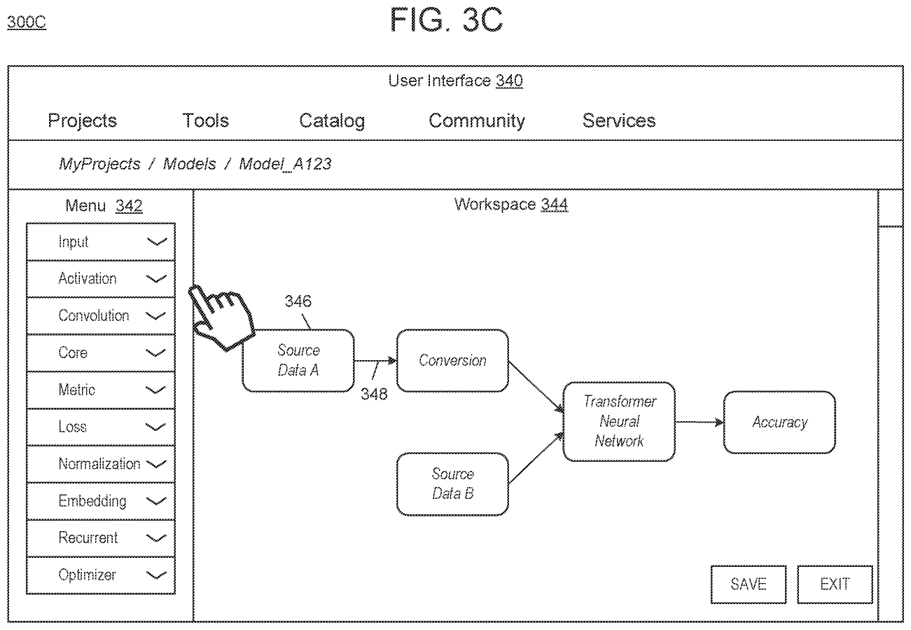

FIG. 3A illustrates a process 300A of training an AI model 322 according to example embodiments. However, it should be appreciated that the process 300A shown in FIG. 3A is also applicable to other types of AI models such as machine learning models, generative AI models, and the like. Referring to FIG. 3A, a host platform 320 may host an integrated development environment (IDE) 310 where AI models, machine learning models, generative AI models, and the like, may be developed, trained, retrained, and the like. In this example, the IDE 310 may include a software application with a user interface accessible by a user device over a network or through a local connection. For example, the IDE 310 may be embodied as a web application that can be accessed at a network address, uniform resource locator (URL), etc., by a device. As another example, the IDE 310 may be locally or remotely installed on a computing device used by a user.

The IDE 310 may be used to design a model (via a user interface of the IDE), such as an AI model that can receive text as input and generate custom imagery, text, etc. which can be displayed on a graphical user interface/dashboard of a software application that displays content during meetings between user devices. The model can be executed/trained based on the training data established via the user interface. For example, the user interface may be used to build a new model. The training data for such a new model may be provided from a training data store such as a database 324 which includes training samples from the web, from customers, and the like. As another example, the training data may be pulled from one or more external data stores 330 such as publicly available sites, etc.

During training, the AI model 322 may be executed on training data via an AI engine 321 of the host platform 320. The training data may include a large corpus of generic images and text that is related to GUI content of topics of interest. In the example embodiments, the training data may include asset data such as web pages of content on different assets, performance data of the assets, predicted performance data of the assets (in the future), portfolio data of users, account data history of users, and the like, however embodiments are not limited thereto. The AI model 322 may learn mappings/connections between text and visual content during the execution and thus create display content (e.g., pages of content, windows, cards, etc.) that can be displayed on the user interface based on input text. When the model is fully trained, it may be stored within the model repository 323 via the IDE 310, or the like.

As another example, the IDE 310 may be used to retrain the AI model 322 after the model has already been deployed. The retraining process may use execution results that have already been generated/output by the AI model 322 in a live environment (including any user feedback, etc.) to retrain the AI model 322. For example, predicted outputs/images that are custom generated by the AI model 322 and the user feedback of the images may be used to retrain the model to further enhance the content that is generated by the model. The responses may include indications of whether the generated content is correct, and if not, what aspects of the images and text are incorrect. This data may be captured and stored within a runtime log 325 or other data store within the live environment and can be subsequently used to retrain the AI model 322.

FIG. 3B illustrates a process 300B of executing a process for training/retraining the AI model 322 via an AI engine 321. In this example, a script 326 (executable) is developed to read data from a database 324 and input the data to the AI model 322 while the AI model is running/executing via the AI engine 321. For example, the script 326 may use identifiers (IDs) of data locations (e.g., table IDs, row IDs, column IDs, topic IDs, object IDs, etc.) to identify locations of the training data within the database 324 and query an API 328 of the database 324. In response, the database 324 may receive the query, load the requested data, and return the data to the script 326 where it is input to the AI model 322. The process may be managed via a user interface of the IDE 310 allowing for supervised learning during the training process. However, it should also be appreciated that the system is capable of unsupervised learning as well.

The script 326 may iteratively retrieve additional training data sets from the database 324 and iteratively input the additional training data sets into the AI model 322 during the execution of the model to continue to train the model. The script may continue the process until instructions within the script direct the script to terminate which may be based on a number of iterations (training loops), total time elapsed during the training process, etc.

FIG. 3C illustrates a process 300C of designing a new AI model via a user interface 340 according to example embodiments. As an example, the user interface 340 may be output as part of the software application which interacts with the IDE 310 shown in FIG. 3A, however, embodiments are not limited thereto. Referring to FIG. 3C, a user can use an input mechanism to make selections from a menu 342 shown on the left-hand side of the user interface 340 to add pieces to the model such as data components, model components, analysis components, etc. within a workspace 344 of the user interface 340.

In the example of FIG. 3C, the menu 342 includes a plurality of GUI menu options which can be selected to reveal additional components that can be added into the model design shown in the workspace 344. Here, the GUI menu options include options for adding features such as neural networks, machine learning models, AI models, data sources, conversion processes (e.g., vectorization, encoding, etc.), analytics, etc. The user can continue to add features to the model and connect them using edges or other means to create a flow within the workspace 344. For example, the user may add a node 346 to a flow of a new model within the workspace 344. For example, the user may connect the node 346 to another node in the flow via an edge 348 creating a dependency within the flow. When the user is done, the user can save the model for subsequent training/testing.

According to various embodiments, the AI model described herein may be trained based on custom defined prompts that are designed to extract specific attributes associated with a goal of a user. These same prompts may be output during live execution of the AI model. For example, a user may input a description of a goal and possibly other attributes. The description/attributes can then be used by the AI model to generate a custom image that enables the user to visualize the goal. The prompts may be generated via prompt engineering that can be performed through the model training process such as the model training process described above in the examples of FIGS. 3A-3C.

Prompt engineering is the process of structuring sentences (prompts) to be understood by the AI model and refining the prompts to generate optimal outputs from the AI model. A prompt may include a description of a goal such as a goal of purchasing a particular type of asset. The prompt may also provide an amount to purchase, a price range at which to purchase, and the like. All of this information may be input to the AI model and used to create custom content about the asset to enable the user to visualize the asset and understand how to add the asset to their portfolio such as the steps to take to obtain the asset. Part of the prompting process may include delays/waiting times that are intentionally included within the script such that the model has time to understand and process the input data.

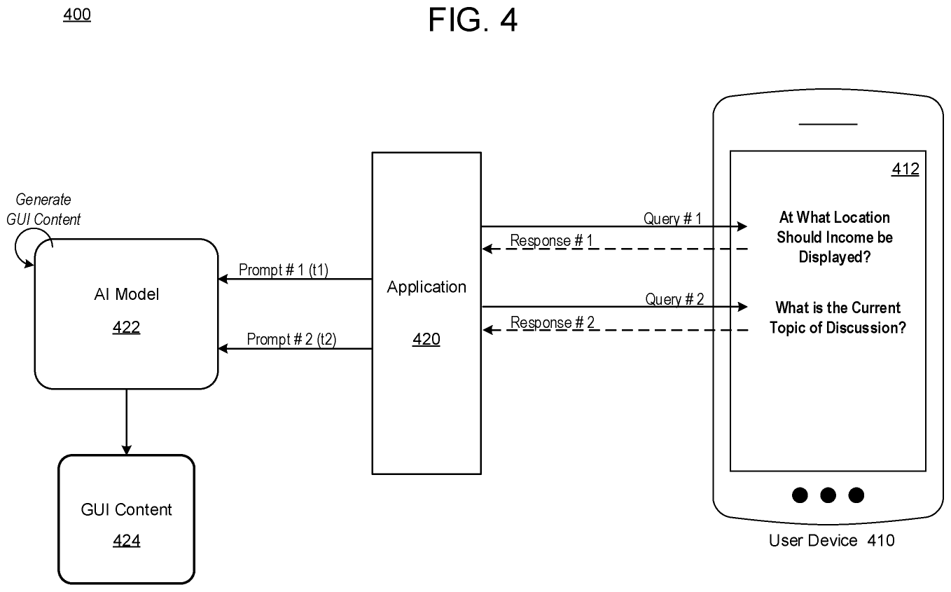

FIG. 4 illustrates a process 400 of an AI model 422 generating GUI content 424 based on prompts according to example embodiments. Referring to FIG. 4, the AI model 422 may be hosted by a host platform (not shown) and may be part of a software application 420 that is also hosted on the host platform. Here, the software application 420 may establish a connection, such as a secure network connection, with a user device 410. The secure connection may be established by the user device 410 uploading a personal identification number (PIN), biometric scan, password, username, transport layer security (TLS) handshake, etc.

In the example of FIG. 4, the software application 420 may control the interaction of the AI model 422 on the host platform and the user device 410. In this example, the software application 420 may output queries on a user interface 412 of the user device 410 with requests for information from the user. The user may enter values into the fields on the user interface corresponding to the queries and submit/transfer both the query by the software application and the response by the user as a “prompt” to the model 422. For example, by pressing a submit button, etc., the software application 420 may combine the query with the response to generate a prompt that is then submitted to the AI model 422 during training of the AI model 422. For example, each prompt may include a combination of a query output by the AI model 422 and the response from the user. For example, if the query is “Please describe the type of assets you prefer” and the response is “Investment vehicles with low risk and less return”, then the text from both the query and the response to the query may be submitted to the AI model 422.

In some embodiments, the software application 420 may deliberately add waiting times between submitting prompts to the AI model 422 to ensure that the model has enough time to understand and process the input. The waiting times may be integrated into the code of the software application 420 or they may be modified/configured via a user interface. Furthermore, the ordering of the prompts and the follow-up queries that are asked may be different depending on the responses given during the previous prompt or prompts. The content within the prompts and the ordering of the prompts can cause the AI model 422 to generate GUI content, and the like. Each prompt may include multiple components including one or more of context, an instruction, input data, and an expected response/output.

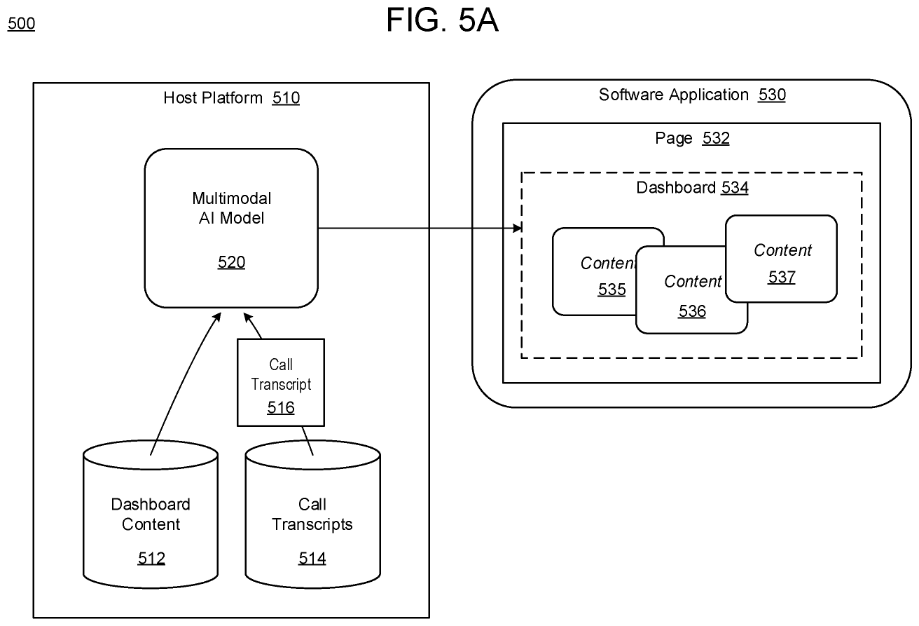

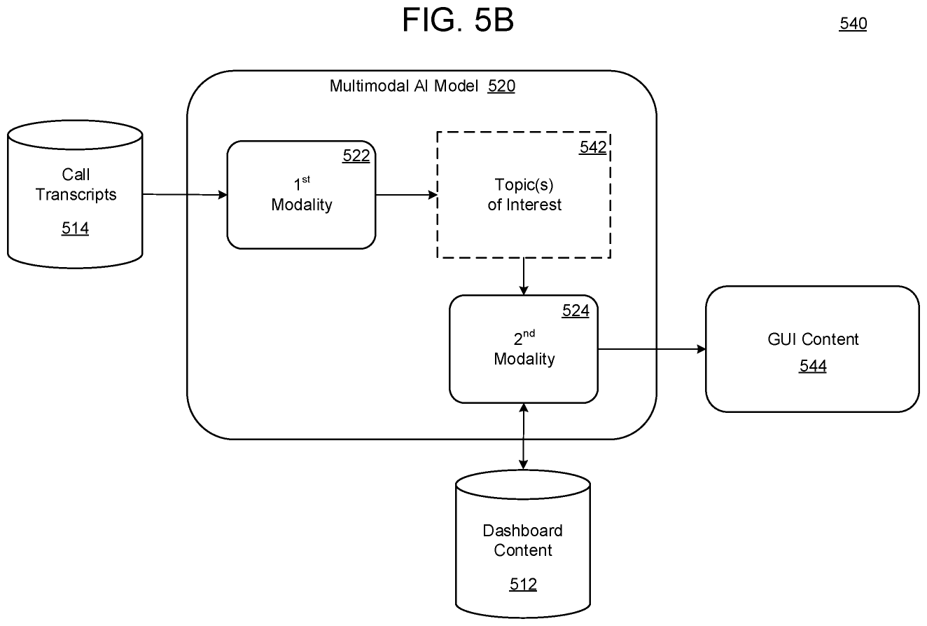

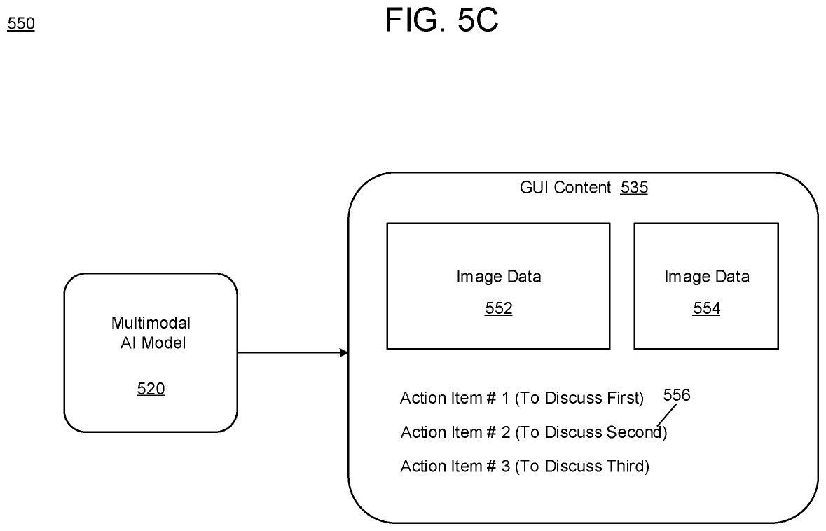

FIGS. 5A-5C illustrate a process of dynamically generating dashboard content or GUI content based on call content or transcripts according to example embodiments. For example, FIG. 5A illustrates a process 500 of dynamically generating a dashboard 534 with content therein based on topics of interest to be discussed during a call. According to various embodiments, a multimodal AI model 520 may receive call content such as audio from a live call, a summary of information to be discussed during the call, such as a call summary, a call transcript, a meeting recording, or the like, and generate graphical user interface content for display on the dashboard 534.

Referring to FIG. 5A, a user such as a financial advisor may request content for display during a call with a customer/client. For example, the advisor may provide a copy of a call transcript 516 or the like from a previous call with the client, a meeting agenda of a call that is about to be conducted, live audio from a call currently being conducted, or the like, and input it to the multimodal AI model 520. The call transcript 516 may be retrieved from a data store 514. As another example, GUI content from a data store 512 may also be input to the multimodal AI model 520. In response, the multimodal AI model 520 may identify topics of interest to be discussed during the call based on the input content and generate new dashboard 534 content based on the identified topics. The new dashboard 534 content may be generated by the multimodal AI model 520 due to its training.

For example, the multimodal AI model 520 may be trained to identify topics from the input call content (historical call transcripts, live call transcripts, etc.), and dynamically generate the new dashboard 534 content based on the identified topics. For example, the training of the multimodal AI model 520 may include inputting a large sample of call content mapped to predefined topics that have previously been identified within the call content thereby enabling the model to learn how to identify the predefined topics from the call content. As another example, the multimodal AI model 520 may also learn a correlation between text and images. For example, the multimodal AI model 520 may learn how to generate image content based on the identified topics by ingesting a large corpus of image content associated with each of a plurality of predefined topics.

Here, the multimodal AI model 520 may be hosted by a host platform such as a cloud platform or the like that also hosts a software application 530. The software application 530 may be accessible online to a user device by opening a web browser and inputting a URL of the software application 530 into the browser. As another example, the software application 530 may be downloaded from a marketplace and installed on the user device. The host platform 510 may connect to the user device over a network such as the Internet. Upon generating GUI content, the multimodal AI model 520 may display the GUI content within a page 532 of the software application 530. In the example of FIG. 5A, the multimodal AI model 520 generates GUI content pieces 535, 536, and 537 based on the identified topics from the call transcript 516 and displays the GUI content pieces 535, 536, and 537 in a dashboard 534 within the page 532 of the software application 530.

FIG. 5B illustrates an example of the multimodal AI model 520 according to example embodiments. Referring to FIG. 5B, the multimodal AI model 520 may include multiple modes (or modalities) in which different processes are executed on different data in combination. For example, in FIG. 5B, a first modality 522 of the multimodal AI model 520 receives call content, such as call transcripts and the like, from the data store 514 and converts it into descriptive text 542 that includes identifiers of one or more topics of interest that are identified from the call content. The topics may correspond to content to be discussed in the future within the call, content that is currently being discussed in the call, content that was previously discussed during the call or another call, or the like. In this example, the descriptive text 542 is provided from the first modality 522 to a second modality 524 of the multimodal AI model 520. In response, the second modality 524 generates the new GUI content 544 based on the descriptive text 542 based on graphical images, web pages, articles, etc. of dashboard content stored in the data store 512.

In the example of FIG. 5B, the first modality 522 processes text content fed into the second modality 524, and in response, GUI content is generated in the form of a page(s) of content, a window(s) of content, and the like. Also, the second modality 524 may determine where in the dashboard to display the new GUI content 544. In some embodiments, the second modality 524 may receive input from the data store 512 with dashboard content. The multimodal AI model 520, using deep learning frameworks, libraries, etc., may learn from text that is ingested and provide image data that matches the topics.

FIG. 5C illustrates a process 550 of generating a content piece 535. Here, the content piece 535 is output by the multimodal AI model 520 on the dashboard 534. In this example, the content piece 535 includes image content including an image 552 and an image 554, and action items 556 with descriptions of information to be discussed during the call. Furthermore, the action items 556 may be arranged in an order based on the order they are to be discussed and/or displayed during the call which may be learned by the model from the input call content.

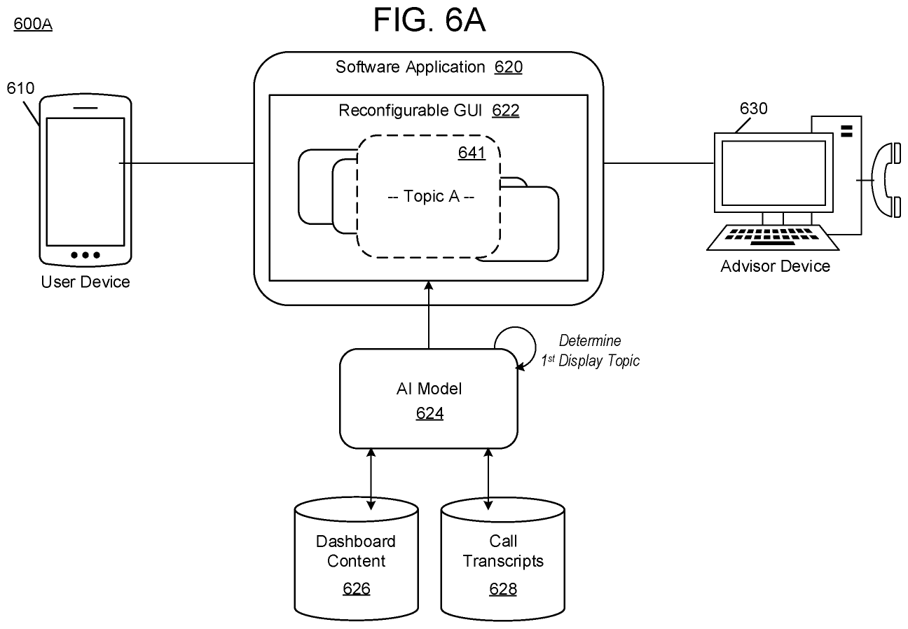

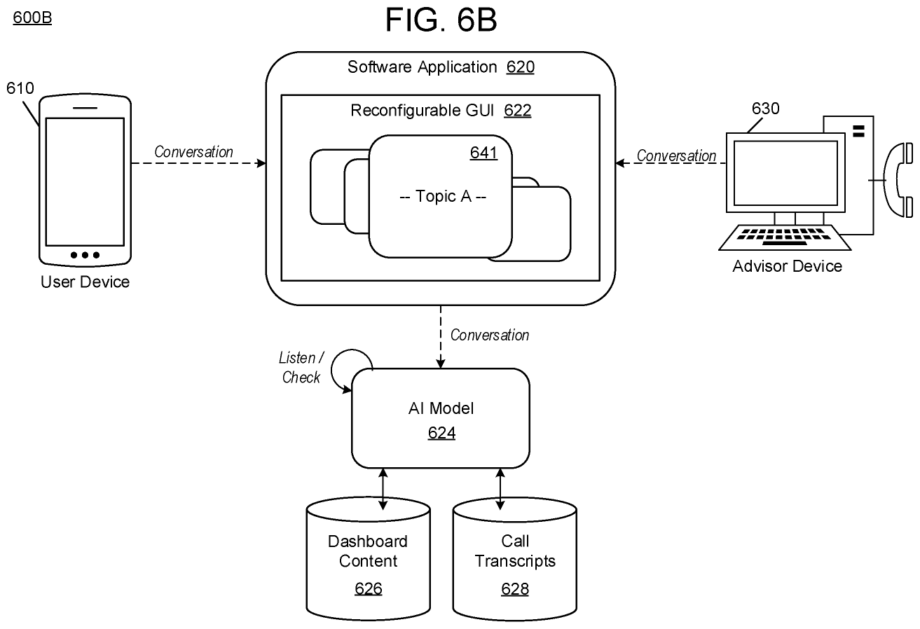

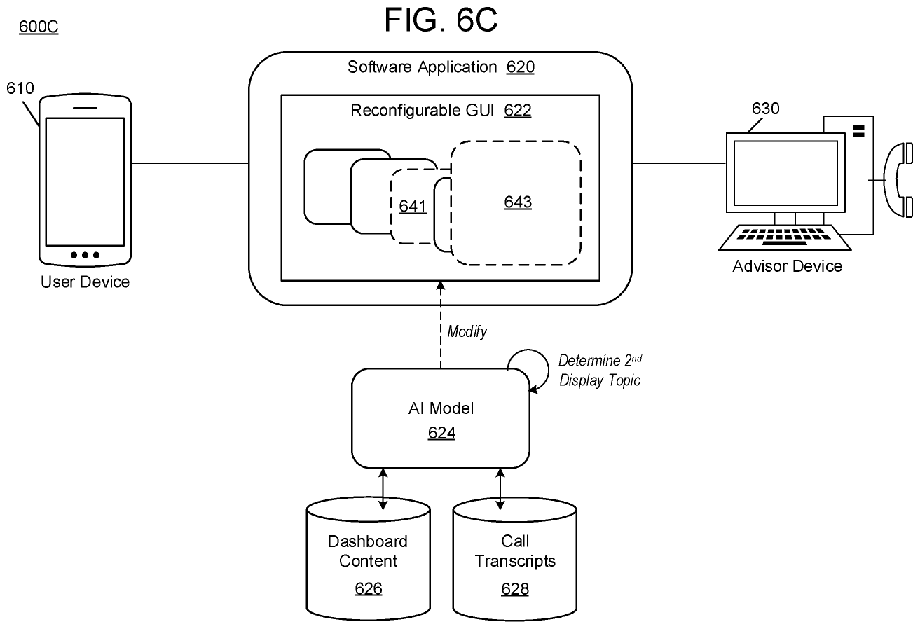

FIGS. 6A-6C are diagrams illustrating a process of reconfiguring a GUI and/or dashboard based on conversation content according to example embodiments. For example, FIG. 6A illustrates a process 600A of initially displaying content during a meeting between a user device 610 and a user device 630. In this example, the user device 610 and the user device 630 may connect to a host platform where a software application 620 is hosted via a network such as the Internet. Here, the software application 620 may be a teleconferencing application or the like which provides a live audio and/or video feed of the users to each other when they are conferencing. The software application 620 may include a reconfigurable GUI or dashboard 622 where content such as documents, images, videos, presentations, files, and the like, may be displayed.

The reconfigurable dashboard 622 may also be referred to as a reconfigurable GUI.

Either of the user device 610 or the user device 630 may upload content to the software application 620 and display it via the reconfigurable dashboard 622. In the example of FIG. 6A, the reconfigurable dashboard 622 initially emphasizes a piece of content 641 within the reconfigurable dashboard 622 that is associated with the first topic or the next topic to be discussed during the call. The emphasis may be generated by enlarging the content, changing the color or shading of the content, changing the brightness of the content, or the like. In addition, other pieces of content may also be shown but are not emphasized in the example of FIG. 6A.

In this example, an AI model 624 may ingest call content prior to the call or during the call and determine the content to be initially displayed within the reconfigurable dashboard 622 and the arrangement/location of the different pieces of content. Here, the AI model 624 may ingest historical dashboard content from a data store 626 and ingest call content from a data store 628 during execution when generating the display content.

Referring now to FIG. 6B, illustrated is a process 600B of determining that the topic of conversation has changed and, in response, determining new GUI content. According to various embodiments, audio may be spoken by the users of either the user device 610 or the user device 630 and transferred between the user devices via the software application 620. Similarly, video may be captured of each of the users by their devices and transferred between the user devices via the software application 620. Thus, each user may have a live video and a live audio feed of the other user via the software application 620.

In the example of FIG. 6B, the software application 620 captures audio from the conversation and records it within a data store such as data store 628. Here, the AI model 624 may analyze the audio to determine if a current topic being discussed has changed to a new topic of discussion. For example, if either user mentions an asset from the portfolio that has yet to be discussed, the AI model 624 may determine that the topic of conversation has changed. Here, the AI model 624 may consume the conversation content and the display content from the reconfigurable dashboard 622, in “real-time”, and rearrange content on the reconfigurable dashboard 622 such as moving positions of pieces already displayed on the reconfigurable dashboard 622, changing a size, shape, color, shading, etc. of a content that is already displayed on the reconfigurable dashboard, removing content from the reconfigurable dashboard, adding new content to the reconfigurable dashboard and the like.

According to various embodiments, the AI model 624 may detect a topic currently being discussed between the user of the user device 610 and the user of the user device 630 is not related to the piece of content 641 that is currently being emphasized within the reconfigurable dashboard 622 but is instead related to a different topic. Here, the audio does not match the content being displayed within the piece of content 641. Referring to process 600C of FIG. 6C, in response, the AI model 624 may identify a different piece of content 643 on the screen associated with a different topic that is being discussed based on the audio and reconfigure the reconfigurable dashboard 622 based on the determination.

For example, the AI model 624 may cause the piece of content 641 that is no longer being discussed to shrink within the reconfigurable dashboard 622 and enlarge the piece of content 643 that is now being discussed.

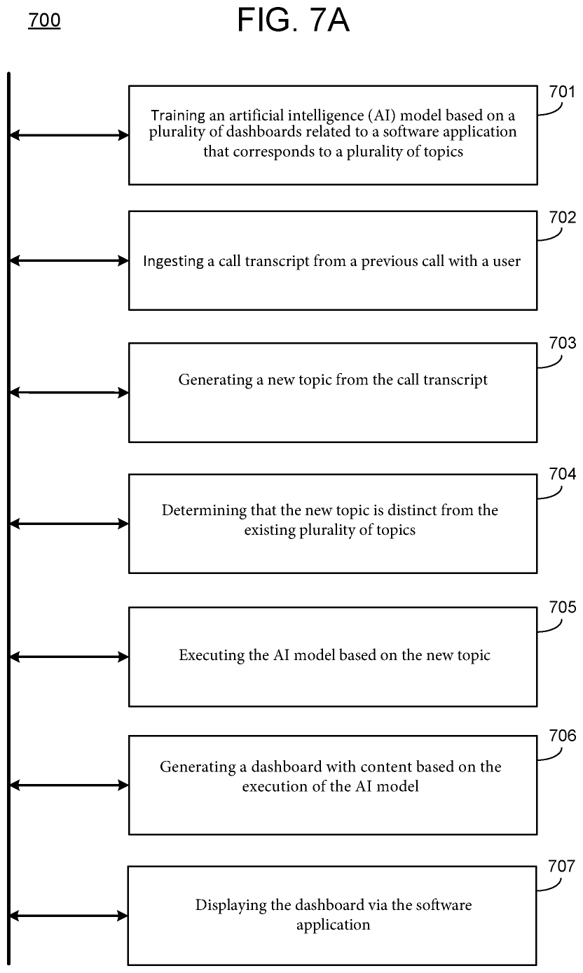

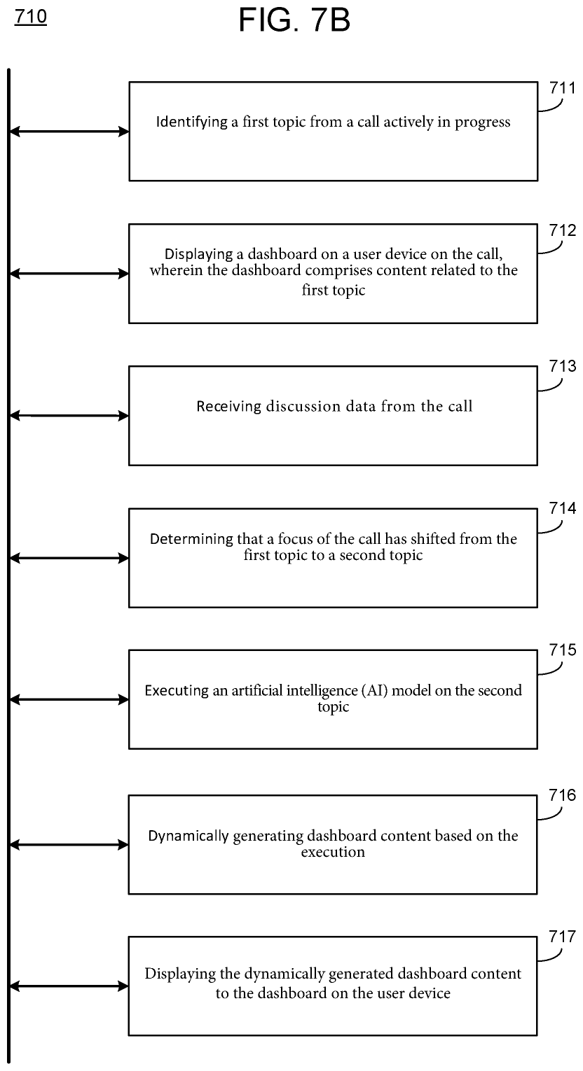

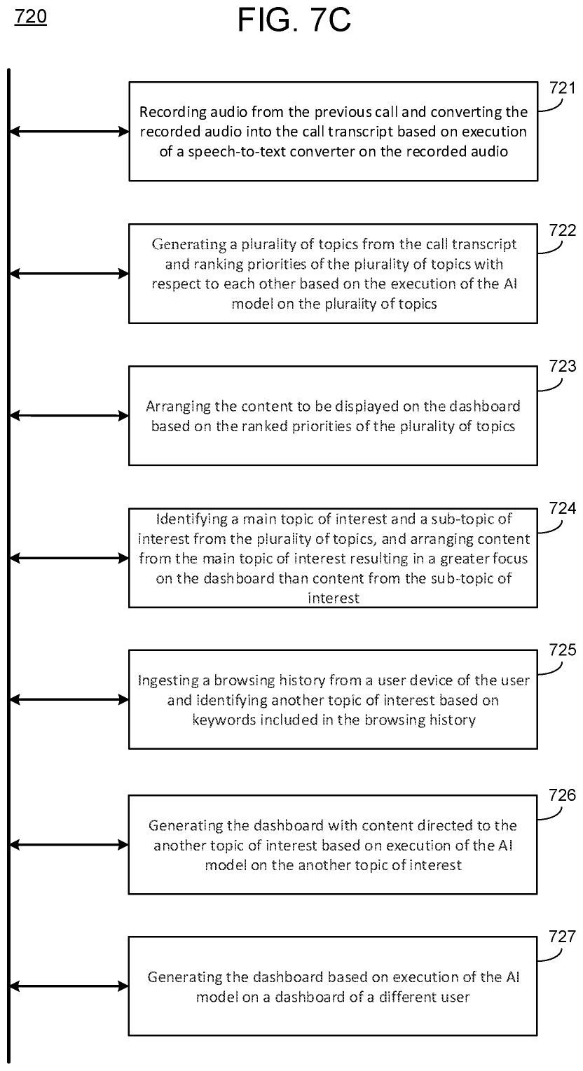

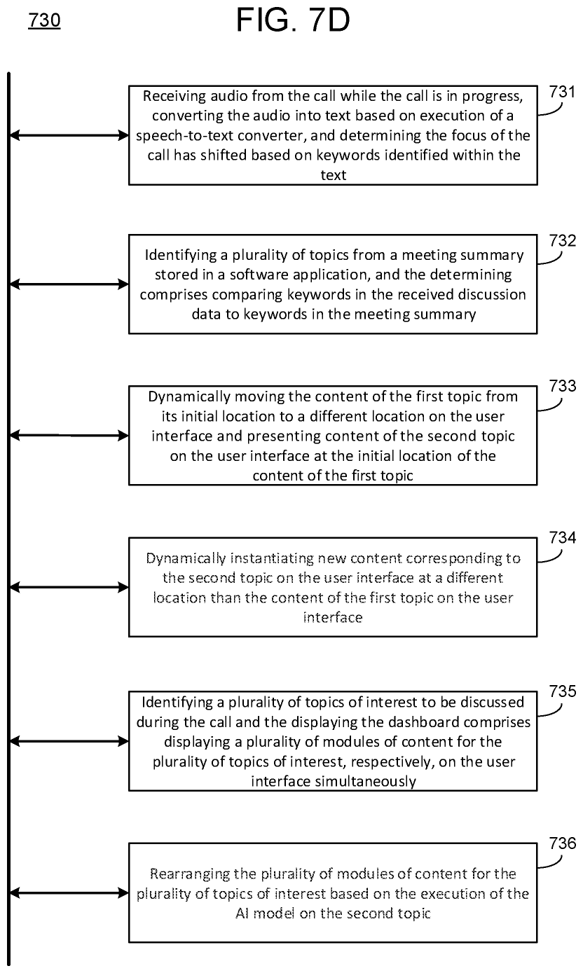

FIG. 7A illustrates a flow diagram for method 700 of dynamically generating a dashboard based on call content according to example embodiments. As an example, the method 700 may be performed by a computing system, a software application, a server, a cloud platform, a combination of systems, and the like. Referring to FIG. 7A, in 701, the method may include training an artificial intelligence (AI) model based on a plurality of dashboards related to a software application that corresponds to a plurality of topics.

In 702, the method may include ingesting a call transcript from a previous call with a user. In 703, the method may include generating a new topic from the call transcript. In 704, the method may include determining that the new topic is distinct from the existing plurality of topics. In 705, the method may include executing the AI model based on the new topic. In 706, the method may include generating a dashboard with content based on the execution of the AI model. In 707, the method may include displaying the dashboard via the software application.

In some embodiments, the method may further include recording audio from the previous call and converting the recorded audio into the call transcript based on execution of a speech-to-text converter on the recorded audio. In some embodiments, the identifying may include identifying a plurality of topics from the call transcript and ranking priorities of the plurality of topics with respect to each other based on execution of the AI model on the plurality of topics. In some embodiments, the generating may include generating the dashboard with a plurality of pieces of dashboard content corresponding to the plurality of topics of interest, respectively, and arranging the plurality of pieces of dashboard content based on the ranked priorities of the plurality of topics of interest.

In some embodiments, the generating may include identifying a main topic of interest and a sub-topic of interest from among the plurality of topics, and arranging content from the main topic of interest such that it has a greater focus on the user interface than content from the sub-topic of interest. In some embodiments, the method may further include ingesting a browsing history from a user device of the user and identifying a second topic of interest based on keywords included in the browsing history. In some embodiments, the generating may include generating the dashboard with at least one piece of content directed to the second topic of interest based on execution of the AI model on the second topic of interest. In some embodiments, the generating may include generating the dashboard with the plurality of pieces of content based on execution of the AI model on a dashboard of a different user.

FIG. 7B illustrates a flow diagram for method 710 of reconfiguring content on a dashboard based on conversation progress according to example embodiments. As an example, the method 710 may be performed by a computing system, a software application, a server, a cloud platform, a combination of systems, and the like. Referring to FIG. 7B, in 711, the method may include identifying a first topic from a call actively in progress. In 712, the method may include displaying a dashboard on a user device on the call, wherein the dashboard comprises content related to the first topic. In 713, the method may include receiving discussion data from the call.

In 714, the method may include determining that a focus of the call has shifted from the first topic to a second topic. In 715, the method may include executing an artificial intelligence (AI) model on the second topic. In 716, the method may include dynamically generating dashboard content based on the execution. In 717, the method may include displaying the dynamically generated dashboard content to the dashboard on the user device.

In some embodiments, the receiving may include receiving audio from the call while the call is in progress, converting the audio into text based on execution of a speech-to-text converter, and determining the focus of the call has shifted based on keywords identified within the text. In some embodiments, the identifying may include identifying a plurality of topics from a meeting summary stored in a software application, and the determining comprises comparing keywords in the received conversation data to keywords in the meeting summary. In some embodiments, the dynamically generating may include dynamically moving the display content of the first topic from its initial location to a different location on the user interface and presenting display content of the second topic on the user interface at the initial location of the display content of the first topic.

In some embodiments, the dynamically generating may include dynamically instantiating a new piece of content corresponding to the second topic on the user interface at a different location than the display content of the first topic on the user interface. In some embodiments, the identifying may include identifying a plurality of topics of interest to be discussed during the call, and the displaying the dashboard comprises displaying a plurality of modules of content for the plurality of topics of interest, respectively, on the user interface simultaneously. In some embodiments, the dynamically generating may include rearranging the plurality of modules of content for the plurality of topics of interest based on execution of the AI model on the second topic.

FIG. 7C illustrates a flow diagram for method 720, according to example embodiments. As an example, the method 720 may be performed by a computing system, a software application, a server, a cloud platform, a combination of systems, and the like. Referring to FIG. 7C, in 721, the method may include recording audio from the previous call and converting the recorded audio into the call transcript based on execution of a speech-to-text converter on the recorded audio. In 722, the method may include generating a plurality of topics from the call transcript and ranking priorities of the plurality of topics with respect to each other based on the execution of the AI model on the plurality of topics. In 723, the method may include arranging the content to be displayed on the dashboard based on the ranked priorities of the plurality of topics. In 724, the method may include identifying a main topic of interest and a sub-topic of interest from the plurality of topics, and arranging content from the main topic of interest resulting in a greater focus on the dashboard than content from the sub-topic of interest. In 725, the method may include ingesting a browsing history from a user device of the user and identifying another topic of interest based on keywords included in the browsing history. In 726, the method may include generating the dashboard with content directed to the another topic of interest based on execution of the AI model on the another topic of interest. In 727, the method may include generating the dashboard based on execution of the AI model on a dashboard of a different user.

FIG. 7D illustrates a flow diagram for method 730, according to example embodiments. As an example, the method 730 may be performed by a computing system, a software application, a server, a cloud platform, a combination of systems, and the like. Referring to FIG. 7D, in 731, the method may include receiving audio from the call while the call is in progress, converting the audio into text based on execution of a speech-to-text converter, and determining the focus of the call has shifted based on keywords identified within the text. In 732, the method may include identifying a plurality of topics from a meeting summary stored in a software application, and the determining comprises comparing keywords in the received discussion data to keywords in the meeting summary. In 733, the method may include dynamically moving the content of the first topic from its initial location to a different location on the user interface and presenting content of the second topic on the user interface at the initial location of the content of the first topic. In 734, the method may include dynamically instantiating new content corresponding to the second topic on the user interface at a different location than the content of the first topic on the user interface. In 735, the method may include identifying a plurality of topics of interest to be discussed during the call and the displaying the dashboard comprises displaying a plurality of modules of content for the plurality of topics of interest, respectively, on the user interface simultaneously. In 736, the method may include rearranging the plurality of modules of content for the plurality of topics of interest based on the execution of the AI model on the second topic.

In one embodiment, the instant solution is leveraged by financial analysis to ingest earnings call transcripts and identify key financial metrics, market trends, and forecasts discussed during the calls. The instant solution then employs a generative AI (GenAI) model to generate comprehensive financial reports. This streamlines the report creation process, allowing analysts to focus on higher-level analysis and insights for clients and investors. A software application executing logic containing the instant solution is responsible for processing earnings call transcripts and identifying key financial metrics, market trends, and forecasts. It extracts relevant information from the transcripts and categorizes it for further analysis. Once the data is structured, the instant solution initiates a message to the GenAI model. The message sent by the instant solution to the GenAI model contains the structured data extracted from the earnings call transcript. The purpose of this message is to request the GenAI model to create comprehensive financial reports based on the identified key metrics and trends. The receiving interface of the GenAI model receives the message. It processes the structured data, performs natural language generation, and generates detailed financial reports. These reports include textual analysis, charts, and graphs summarizing the financial performance and trends discussed during the earnings call. A message is sent back to the instant solution from the GenAI model containing the AI-generated financial reports. This message aims to provide the completed reports to the financial analysts, enabling them to focus on higher-level analysis and insights for their clients and investors.

In one embodiment, investment firms can utilize the instant solution to process call transcripts of company briefings and analyst discussions. The instant solution identifies emerging investment opportunities and risks in real time. It combines this information with generative AI to create personalized investment insights for clients. Investors receive automated reports and recommendations tailored to their portfolios and risk tolerance. The instant solution processes call transcripts of company briefings and analyst discussions in real time. It identifies emerging investment opportunities and risks from the transcripts. Once the analysis is complete, the instant solution initiates a message to the GenAI model. The message that the instant solution sends to the GenAI model contains the identified investment opportunities, risks, and relevant financial insights. The purpose of this message is to request the GenAI model to create personalized investment insights. The GenAI model receives the message, processes the identified opportunities and risks, and combines this information with portfolio data and risk tolerance information. The GenAI model then generates personalized investment reports and recommendations. A message is returned containing personalized investment insights, including reports and recommendations. This message aims to provide investors with automated and tailored insights for their portfolios.

In one embodiment, financial institutions can employ the instant solution to monitor compliance during live financial advisory calls. The instant solution continuously ingests and analyzes transcripts, identifying potential real-time compliance issues. When compliance breaches are detected, the instant solution utilizes a generative AI model to draft warnings or corrective actions, ensuring that financial advisors adhere to regulatory guidelines. The software application monitors compliance during live financial calls. It continuously ingests and analyzes the call transcripts in real time, identifying potential compliance issues. When a compliance breach is detected, the instant solution initiates a message to a Generative AI Compliance System. The sent message contains details about the detected compliance issue and a request for assistance in drafting warnings or corrective actions. The Generative AI Compliance System receives the message and processes the information about the compliance breach using generative AI to draft warnings or corrective actions in real time. The Generative AI Compliance System sends a response message to assist financial advisors in adhering to regulatory guidelines by providing real-time compliance support.

In one embodiment, banks and brokerage firms can integrate the instant solution with AI-powered chatbots for customer support. When customers inquire about specific financial topics during calls or chats, the instant solution ingests and analyzes call transcripts to understand their needs. It then sends a message to the GenAI model to provide detailed responses, investment advice, or relevant product recommendations, enhancing the customer service experience. The software application analyzes call transcripts during customer calls or chats. When a customer inquires about specific financial topics, the software application identifies the relevant topic and sends a message to an AI-Powered Financial Chatbot System containing details about the customer's inquiry and a request to generate a detailed response or provide relevant product recommendations. The AI-Powered Financial Chatbot System receives the message from the software application and analyzes the call transcript for context, using a generative AI model to generate a detailed response, investment advice, or product recommendations in real-time. The response is sent to the application and is used to enhance the customer service experience by providing immediate and accurate information based on the customer's inquiry. This interaction enables banks and brokerage firms to offer responsive and informative customer support by leveraging AI-powered chatbots integrated with the software application.

In one embodiment, the instant solution supports the actions of a financial advisor conducting a call with a client. The instant solution identifies the main topic of interest as the client's investment portfolio. Initially, the dashboard displays essential data related to the client's current investments, including asset allocation, performance metrics, and risk assessment. However, as the conversation progresses, the AI model detects that the client is expressing concerns about the recent market volatility. Using keywords and sentiment analysis, the instant solution identifies this shift in focus and dynamically generates content related to market trends, historical data, and strategies for managing a volatile market. The dashboard is updated to display this new content prominently, ensuring that the advisor can address the client's concerns effectively. Additionally, the instant solution can rearrange content modules, prioritizing market volatility and risk management information over less relevant investment performance metrics.

For example, the financial advisor initiates the session at the beginning of the call using the software application. Based on the call context, the instant solution identifies the client's investment portfolio as the primary topic and displays the initial dashboard content containing asset allocation, performance metrics, and risk assessment. As the conversation progresses, the client expresses concerns about recent market volatility. The client's audio input, which includes keywords related to market volatility and sentiment analysis that detect the client's shift in focus, is captured by the instant solution. Upon detecting the shift in focus, the instant solution triggers the AI model to execute on the new topic: market volatility and risk management. The AI model generates content dynamically, including market trend analysis, historical data, and strategies for managing a volatile market. The instant solution sends a content update message to the financial advisor's interface, instructing it to replace or reposition the existing content on the dashboard with the newly generated content related to market volatility. This ensures that the advisor has the most relevant information at hand to address the client's concerns effectively. Additionally, the instant solution sends a rearrangement message to the financial advisor's interface, instructing it to prioritize the display of market volatility and risk management information over less relevant investment performance metrics. The rearranged dashboard ensures that the advisor can focus on the most critical aspects of the conversation. The conversation between the advisor and the client continues, with the dashboard content remaining dynamic. If the client's focus shifts again during the call, the instant solution repeats the process of detecting, generating, and updating content as necessary. The current embodiment leverages real-time audio analysis, keyword detection, and sentiment analysis to ensure that the dashboard content aligns with the client's immediate concerns, enhancing the effectiveness of the financial advisor-client interaction. Messages are sent to instruct content updates and rearrangements, ensuring that the dashboard provides up-to-date and relevant information throughout the call.

In one embodiment, the instant solution is tailored for a real estate investment when conducting calls with potential investors. The main topic of interest revolves around various real estate investment opportunities. Initially, the dashboard showcases property listings, financial projections, and return on investment (ROI) data. However, during a call with a potential investor, the instant solution detects a shift in focus as the investor expresses interest in a specific property type, such as commercial real estate. The AI model identifies this shift based on keywords like “commercial properties” and “rental income.” In response, the instant solution dynamically generates content featuring commercial property listings, market trends, and financial models specifically related to commercial real estate investments. The dashboard adapts by replacing or repositioning residential property data with the new content, ensuring that the investor's current area of interest is prominently highlighted.

For example, at the start of the call, the dashboard is initialized with default content, including property listings, financial projections, and ROI data relevant to various real estate investment opportunities. As the conversation with a potential investor unfolds, the instant solution detects a shift in focus when the investor expresses interest in commercial real estate. Keywords like “commercial properties” and “rental income” trigger the instant solution's recognition of this shift. Upon detecting the shift in focus, the instant solution activates the AI model to execute tasks related to commercial real estate investments. The AI model dynamically generates content, including commercial property listings, market trends, and financial models tailored specifically to commercial real estate opportunities. The instant solution sends a content update message to the user interface, instructing it to replace or reposition the existing residential property data on the dashboard with the newly generated content that pertains to commercial real estate investments. This ensures that the investor's current area of interest is prominently highlighted on the dashboard. The conversation continues while the dashboard content remains dynamic. If the investor's focus shifts again during the call, the instant solution repeats the process of detecting, generating, and updating content as necessary. In this embodiment, the instant solution leverages keyword detection to identify shifts in the investor's focus and provides targeted content updates accordingly. Messages are sent to instruct the user interface to adapt the dashboard content to the investor's immediate area of interest, enhancing the effectiveness of the real estate investment discussion.

As a further example, the instant solution initializes the dashboard with default content related to various real estate investment opportunities. This default content includes property listings, financial projections, and ROI data for a broad range of properties. As the call progresses, the instant solution continuously monitors the conversation using a speech-to-text converter, converting audio into text. It employs natural language processing techniques to identify keywords and phrases indicative of a shift in the investor's focus. For example, when the potential investor mentions terms like “commercial properties” or “rental income,” the instant solution's AI model recognizes these keywords. Upon detecting a shift in focus, the instant solution triggers the execution of its AI model, specifically the GenAI model. The AI model is trained to respond to various topics, including different types of real estate investments. In this case, it activates the branch of the model related to commercial real estate investments. The GenAI model generates new content tailored to the investor's area of interest, which, in this instance, is commercial real estate. This content may include updated property listings, market trends specific to commercial properties, and financial models geared toward analyzing commercial real estate investments. The instant solution sends a content update instruction message to the user interface. This message contains information on how the dashboard should be modified to reflect the new content. For example, it may instruct the user interface to replace or reposition the existing residential property data on the dashboard with the newly generated content related to commercial real estate investments. The user interface processes the content update message and dynamically adapts the dashboard. It removes or repositions the previous content related to residential properties and prominently displays the commercial real estate investment content. This ensures that the investor's current area of interest is front and center on the dashboard. The conversation between the real estate advisor and the potential investor continues, with the dashboard content remaining dynamic. If the investor's focus shifts again during the call, the instant solution repeats the process of keyword detection, AI model execution, content generation, and content update instructions to adapt the dashboard accordingly. In the current embodiment, the components include the AI model, content update mechanisms, and user interface interaction, which work seamlessly to create a personalized and responsive dashboard for real estate investment discussions. Keyword detection plays a pivotal role in identifying shifts in focus, enabling the instant solution to provide targeted and timely content updates. This dynamic adaptation enhances the effectiveness of the conversation and assists real estate professionals in addressing the specific needs and interests of potential investors.

In one embodiment, the instant solution is designed for a retail trading platform. During user calls, the main topic of interest is stock trading and investment strategies. The initial dashboard provides real-time stock prices, portfolio balances, and watchlist data. However, as a user engages in a call and discusses a particular stock's potential based on recent news, the AI model detects the shift in focus. Keywords such as “earnings report” and “upcoming announcements” trigger the instant solution to dynamically generate content related to the discussed stock. The dashboard is updated to prominently display news articles, earnings calendar, and technical analysis charts specific to the stock in question. This ensures that the user can make informed trading decisions during the call. Furthermore, the instant solution may rearrange the content modules, prioritizing information related to the discussed stock over general market data and enhancing the user's trading experience.

For example, the instant solution starts by initializing the dashboard with default content related to stock trading. This content includes real-time stock prices, portfolio balances, and user watchlist data. As the user engages in a call and discusses specific stocks or investment opportunities, the instant solution continuously monitors the conversation. It employs a speech-to-text converter to transcribe audio into text and uses natural language processing to identify keywords and phrases indicative of a shift in focus. For example, when users mention “earnings report” or “upcoming announcements,” the instant solution's AI model recognizes these keywords. Upon detecting a shift in focus, the instant solution triggers the execution of its AI model, specifically the GenAI model. The AI model is trained to respond to various topics, including different stocks and investment opportunities. In this case, it activates the branch of the model related to the discussed stock. The GenAI model generates new content tailored to the discussed stock. This content may include news articles related to the stock, an earnings calendar showing upcoming announcements, and technical analysis charts specific to the stock's performance. The instant solution sends a content update instruction message to the user interface. This message contains information on how the dashboard should be modified to reflect the new content. For example, it may instruct the user interface to prominently display the news articles, earnings calendar, and technical analysis charts related to the discussed stock. The user interface processes the content update message and dynamically adapts the dashboard. It replaces or repositions the previous content with the newly generated content specific to the discussed stock. This ensures that the user has easy access to information relevant to their trading decision-making process. The conversation continues while the dashboard content remains dynamic. If the user's focus shifts to another stock or topic during the call, the instant solution repeats the process of keyword detection, AI model execution, content generation, and content update instructions to adapt the dashboard accordingly.

In this embodiment, the components enable the creation of a highly personalized and responsive trading dashboard. Keyword detection serves as a crucial mechanism for identifying shifts in the user's focus, allowing the instant solution to provide timely and relevant content updates. This dynamic adaptation enhances the user's trading experience, ensuring that they have access to the most pertinent information during their call, ultimately supporting informed trading decisions.

For example, the instant solution starts by initializing the dashboard with default content related to stock trading. This initial dashboard layout includes real-time stock prices, portfolio balances, and user watchlist data. A speech-to-text converter and natural language processing are employed to continuously monitor the conversation. It identifies keywords and phrases indicative of a shift in focus. For example, terms like “earnings report” or “upcoming announcements” trigger the instant solution to assess the shift in focus from the prior content. Once the instant solution detects a shift in focus through its AI model, it activates the relevant branch of the model related to the discussed stock. The AI model has been trained to respond to various topics, including different stocks and investment opportunities. The GenAI model generates new content in response to the discussed stock. This content may encompass news articles related to the stock, an earnings calendar indicating upcoming announcements, and technical analysis charts specific to the stock's performance. The instant solution sends a content update instruction message to the user interface. This message contains detailed instructions on how the dashboard should be modified to reflect the new content. For instance, it may specify that the news articles, earnings calendar, and technical analysis charts related to the discussed stock should be prominently displayed. The user interface, guided by the content update message, dynamically adapts the dashboard. It replaces or repositions the previous content with the newly generated content specific to the discussed stock. This ensures that the user has immediate access to information that is directly relevant to their trading decisions. The conversation continues while the dashboard content remains dynamic. The instant solution repeats the process if the user's focus shifts to another stock or topic during the call. It detects keywords, executes the AI model, generates new content, and issues content update instructions, allowing the dashboard to adapt in real-time. The instant solution is the underlying technology that enables the described embodiment to function seamlessly. Its components, including keyword detection, AI model execution (particularly the GenAI model), and content update instructions, work in tandem to create a highly personalized and responsive trading dashboard. This dynamic adaptation enhances the user's trading experience by ensuring they have access to the most relevant and timely information during their call, ultimately supporting well-informed trading decisions.

In one embodiment, the instant solution is designed to train an AI model, leveraging a diverse range of dashboards associated with a software application, each addressing various topics. This training process equips the AI model with the capability to comprehend and generate content related to these distinct subjects. When a call transcript from a previous interaction with a user is ingested, the instant solution utilizes natural language processing techniques to identify a specific topic of interest within the transcript. This identification is based on the extraction of relevant keywords or themes mentioned in the conversation. Subsequently, the AI model is executed, and its operation is tailored to the identified topic of interest. The AI model leverages its training data to generate content directly related to the topic. The generated content serves as the foundation for the creation of a dashboard. This dashboard encapsulates the topic-specific content, which may include textual information, visual elements like images or graphs, and other forms of data visualization. The process begins with training an AI model. This training phase involves gathering various dashboards related to a software application, each addressing different topics. These dashboards serve as training data for the AI model. When a call with a user concludes, a call transcript from that conversation is ingested into the instant solution. This transcript is a textual representation of the entire conversation, capturing user queries and responses. The instant solution analyzes the call transcript to identify the specific topic of interest. This identification process is accomplished by extracting keywords or themes from the transcript that indicate the subject matter of the conversation. These keywords serve as signals for determining the topic. Based on the identified topic of interest, the AI model is executed. This execution is tailored to the specific topic, meaning that the model's algorithms and processes are focused on generating content related to that topic. With the AI model in operation, it generates content relevant to the identified topic. This content can encompass various forms, such as text, images, charts, or any other data visualization elements. The AI model's output forms the foundation for the dashboard. The final step in the message flow involves making the generated dashboard accessible to the user. This is achieved by displaying the dashboard via the software application's user interface. The user can interact with the content, gaining insights and information related to the topic of interest.

In one embodiment, the instant solution is configured to record audio from the previous call. This audio recording captures the user's spoken conversation. Following the audio recording, the instant solution employs a speech-to-text converter to transcribe the recorded audio into text form. This conversion process transforms spoken words into a textual representation, creating a call transcript that can be analyzed and processed more effectively. These additional steps enhance the instant solution's ability to work with different types of input data, allowing it to process both text-based call transcripts and audio recordings. The subsequent identification of the topic of interest and the execution of the AI model remains integral parts of the message flow, ensuring that the generated dashboard remains relevant and informative based on the chosen input medium. The instant solution possesses the capability to record audio data from a previous call with a user. This recording function allows the instant solution to capture the spoken interactions and conversations that occurred during a call. The instant solution is further equipped with the ability to convert the recorded audio data into a textual format. This conversion process is achieved through the execution of a speech-to-text converter, a software component or module designed to transcribe spoken words into written text.

For example, the instant solution starts recording audio from the ongoing conversation as a call begins. This recorded audio captures all the spoken interactions during the call. Simultaneously, the instant solution employs its speech-to-text conversion functionality. It executes a speech-to-text converter, which processes the recorded audio and transforms it into a textual call transcript. This transcript represents a written version of the conversation. After obtaining the call transcript, the instant solution, in coordination with the AI model, identifies a topic of interest. It achieves this by analyzing the keywords and content within the call transcript. The topic identified is a subject or theme that is relevant to the user's call. The AI model is then executed based on the identified topic of interest. The AI model processes the topic-specific data from the call transcript and generates content tailored to that topic using its training and capabilities. With the output from the AI model, the instant solution proceeds to generate a dashboard. This dashboard includes content specifically related to the topic of interest. The content can take various forms, such as text, images, charts, or any other type of data visualization. The generated dashboard is displayed via the software application. The user can now access and interact with the dashboard, which provides them with valuable information and insights related to the topic discussed during the call.

In one embodiment, multiple topics are identified from the call transcript. These topics represent various subjects or themes discussed during the call. After identifying these multiple topics, the instant solution utilizes the AI model's capabilities to rank or assign priorities to these topics concerning each other. This ranking is based on the results obtained from the execution of the AI model on each of the identified topics. To perform the prioritization, the instant solution leverages the AI model's execution results. It analyzes the output generated by the AI model for each topic and uses this information to determine the importance or relevance of each topic in relation to the others. Once the priorities are established, the instant solution can then proceed to generate customized content and dashboards for the user. The content created is tailored to reflect the prioritized topics, ensuring that the most relevant and significant information is presented prominently. This prioritization mechanism enhances the user's experience by ensuring that the most pertinent topics are given greater attention in the generated content. It allows the user to focus on what is most relevant based on the priorities determined by the AI model.

In one embodiment, the instant solution, as part of its configuration, possesses the capability to arrange the content intended for display on the dashboard. The arrangement is determined by considering the ranked priorities assigned to the multiple topics identified from the call transcript. To achieve this, the instant solution utilizes the prioritization information previously determined. Each topic is associated with a priority level based on the execution results of the AI model. The instant solution considers these priority levels when determining the layout and presentation of content on the dashboard. The result is a customized dashboard where the content is organized and displayed in a manner that aligns with each topic's relative importance or relevance. Topics with higher priorities receive greater prominence, ensuring that the user is presented with the most critical information. This approach enhances the user's experience by providing them with a dashboard that reflects the importance of different topics discussed during the call. Users can quickly identify and focus on the most relevant content, improving their ability to absorb and respond to critical information.

In one embodiment, as part of its configuration, the instant solution is equipped to differentiate between a main topic of interest and a sub-topic of interest among the plurality of topics identified from the call transcript. This differentiation is crucial for understanding the hierarchy and significance of various discussion points. After identifying the main topic and sub-topic, the instant solution applies priority-based logic to determine how to arrange the content on the dashboard. Specifically, it arranges content related to the main topic of interest to ensure it receives greater focus and prominence on the dashboard compared to content related to the sub-topic of interest. This arrangement strategy is designed to enhance the user's experience by directing their attention towards the main topic, which is typically the most critical aspect of the discussion. The user can quickly grasp the primary subject matter and any associated details because of the emphasis of the main topic. The result is a dashboard that provides an improved user experience by highlighting the main topic while still accommodating relevant information about sub-topics. This enhances the user's ability to engage with and respond to the most important aspects of the call.

In one embodiment, the instant solution is configured to ingest a browsing history directly from the user's device. This browsing history may include records of websites visited, searches conducted, and other online activities performed by the user. Upon obtaining the browsing history data, the instant solution performs a keyword analysis. This analysis involves scanning the browsing history for keywords and phrases that indicate the user's interests, preferences, or focus areas. Based on the keyword analysis, the instant solution identifies additional topics of interest that align with the keywords found in the browsing history. These topics may encompass a wide range of subjects including, but not limited to, products, services, information, or activities that the user has demonstrated interest by their online behavior. The identified topics from the call transcript, combined with the topics derived from the browsing history, contribute to a comprehensive pool of topics of interest associated with the user. This diverse range of topics reflects the user's multifaceted interests and enables a more comprehensive understanding of their preferences. The instant solution leverages this expanded pool of topics to enrich the content of the generated dashboard. Content related to the additional topics of interest identified from the browsing history is integrated into the dashboard alongside the content derived from the call transcript. By incorporating topics from both the call transcript and the browsing history, the instant solution creates a highly personalized and relevant user experience. The dashboard reflects the user's interests and preferences, ensuring that the displayed content aligns closely with what is important to the user. Importantly, this capability enables the instant solution to adapt continually to the user's evolving interests as reflected in their online activities. It ensures that the dashboard remains current and tailored to the user's changing preferences.

In one embodiment, the instant solution is configured to execute the AI model on the additional topic of interest identified from the browsing history. This execution involves processing and analyzing data related to the newly identified topic. Based on the execution of the AI model on the additional topic, the instant solution dynamically generates content that is specifically directed toward this topic. This content creation is driven by the insights and information extracted from the data associated with the newly identified topic. The generated content related to the topic of interest seamlessly integrates with the existing dashboard content. It becomes an integral part of the dashboard, ensuring that the user has access to comprehensive and relevant information across various areas of interest. By including content directed towards the newly identified topic, the instant solution further tailors the user's experience to their diverse range of interests. Users can explore and engage with information that aligns with their call-related topics and online activities. Importantly, this capability allows the dashboard to adapt to the user's current areas of interest in real time. As the user's browsing behavior evolves, the instant solution continues to execute the AI model on new topics, ensuring that the dashboard remains up-to-date and relevant. The instant solution delivers customized content experiences, ensuring that users receive information and insights that align precisely with their preferences and activities, both during calls and while browsing online.

In one embodiment, the instant solution is configured to execute the AI model on a dashboard that belongs to a different user. This execution involves processing and analyzing data related to the different user's dashboard, which may contain topics, preferences, and content relevant to the current user. To execute the AI model on the different user's dashboard, the instant solution acquires relevant data from the dashboard associated with the different user. This data may include information about topics of interest, content preferences, user behavior, and other relevant data points. Once the data from the different user's dashboard is acquired, the instant solution analyzes this data to extract insights and patterns. It identifies topics, preferences, or content that may be of interest to the current user based on the analysis of the different user's dashboard. Leveraging the insights obtained from the analysis of the different user's dashboard, the instant solution dynamically generates a dashboard for the current user. This newly generated dashboard incorporates content and topics that align with the insights derived from the different user's dashboard. The instant solution delivers user-centric experiences by adapting the dashboard content to align with the interests and preferences of the current user. It ensures that users can access and explore information that resonates with their evolving areas of interest. The current embodiment embodies the concept of knowledge transfer between users through AI-driven content generation. It allows users to benefit from insights and content generated based on the experiences and preferences of other users, creating a collaborative and knowledge-sharing environment. By generating content based on insights from a different user's dashboard, the instant solution provides personalized recommendations and content suggestions to the current user. This enhances the user's experience by offering relevant and engaging information. The current embodiment extends the capabilities of the instant solution by allowing the instant solution to execute the AI model on a dashboard of a different user and generate a dashboard for the current user based on the insights and content identified from the different user's dashboard. This feature promotes cross-user knowledge sharing and enhances the personalization of content and recommendations for the current user.

In one embodiment, the instant solution is specially configured to perform a series of operations. Firstly, it identifies a primary topic of discussion from a list of various topics relevant to the conversation or application. For example, this primary topic in a customer service call could be a specific product or service. After identifying the primary topic, the instant solution proceeds to display a dashboard on the user's device. This dashboard is populated with content tailored to the primary topic, providing the user with pertinent information or visuals. As the conversation continues, the instant solution continually collects conversation data, whether in the form of spoken words, text messages, or multimedia content. It vigilantly monitors this data, analyzing it for cues that suggest a shift in the conversation's focus. This shift is detected by identifying specific keywords or phrases, such as product names or service issues, within the conversation data.

When the instant solution discerns that the conversation has transitioned to a different topic, it adapts by executing a specialized AI model designed to handle this new subject matter. This AI model is referred to as the GenAI model in the instant solution. Once the GenAI model is engaged, it dynamically generates dashboard content tailored to the newly identified topic. This content could encompass informative text, visual aids, or any other relevant data. Crucially, the instant solution ensures that this dynamically generated content is promptly delivered to the user's dashboard in real time. This means that users have access to up-to-date and contextually relevant information throughout the conversation or application usage.

In one embodiment, the instant solution employs an AI model to create a responsive and adaptive user experience. It begins by identifying the main topic, displaying relevant content, monitoring conversation data, detecting shifts in focus, engaging a specialized AI model, dynamically generating the content, and delivering this content in real time to keep users informed and engaged. This approach enhances user interactions across various applications, from customer support to financial advising, and the like.

For example, the user initiates a call or session with a software application, such as a financial advisory tool, customer support platform, or any application where dynamic content adaptation is beneficial. The instant solution identifies the primary topic of interest for the call based on the context or user input. For instance, if it's a financial advisory application, the primary topic could be the user's investment portfolio. The instant solution generates an initial dashboard tailored to the primary topic and displays it on the user's device. In the financial advisory example, this dashboard might include details on the user's current investments, asset allocation, and performance metrics. As the call progresses, the instant solution continually collects conversation data, which could include audio from the call, text chat, or any relevant information exchanged during the session. The instant solution actively monitors the conversation data for keywords or phrases that suggest a shift in the conversation's focus. For instance, if the user starts expressing concerns about market volatility during a financial advisory call, keywords like “market volatility” or “risk management” trigger the shift detection. Once a shift in focus is detected, the instant solution engages the specialized GenAI model designed to handle the new topic. In the example, this could involve activating the GenAI model trained for market trends and risk management. The GenAI model dynamically generates new content specific to the shifted topic. The financial advisory call could include market trend analysis, historical data, and risk mitigation strategies. Crucially, the instant solution ensures that this newly generated content is updated in real time on the user's dashboard. The dashboard now prominently displays the market volatility content to effectively address user concerns. If needed, the instant solution may rearrange content modules on the dashboard, prioritizing the new market volatility information over less relevant investment performance metrics. The user can now engage with the updated content and continue the conversation with access to contextually relevant information.

In one embodiment, the instant solution is designed to accommodate users engaged in various types of calls, including those involving financial advisors, customer support, or any context where dynamic content adaptation is valuable. When a call is initiated, the instant solution identifies the primary topic of interest and records the audio from the ongoing call. This audio is processed in real-time using a speech-to-text converter, transforming spoken words into text-based conversation data. While the call is in progress, the instant solution's AI model continuously monitors this transcribed conversation data for specific keywords or phrases indicative of a shift in the conversation's focus. For instance, keywords like “market volatility” or “earnings report” might trigger the AI model during a financial advisory call. When such keywords are detected, the instant solution recognizes that the focus of the conversation has shifted from the initial topic to a new one. To address this shift, the instant solution engages an appropriate GenAI model that has been trained to handle the newly identified topic. In the financial advisory context, this might involve activating a GenAI model specialized in market analysis or earnings reports. The GenAI model then dynamically generates content based on the detected topic. For example, if the user starts discussing market trends, the GenAI model could generate market trend analysis, historical data, or stock-specific information. Crucially, this newly generated content is reflected in real-time updates on the user's dashboard. This ensures that the user has access to the most relevant information aligned with the current focus of the conversation. In summary, the current embodiment is enabled through a combination of audio recording, speech-to-text conversion, keyword detection, GenAI model engagement, and real-time content updates. It allows the instant solution to adapt the displayed content dynamically based on keywords identified within the transcribed text, ensuring that the dashboard always aligns with the evolving needs and topics of the ongoing conversation.

For example, the process begins when a user initiates a call with a financial advisor on a system implementing the instant solution. The instant solution's dashboard initially displays information related to the user's investment portfolio, including asset allocation, performance metrics, and risk assessment. As the call progresses, the instant solution records the audio from the ongoing conversation in real time. This audio stream is then passed through a speech-to-text converter, which transcribes the spoken words into text-based conversation data. Simultaneously, the instant solution's AI model monitors the transcribed conversation data for specific keywords or phrases that may indicate a shift in the conversation's focus. For instance, if the user mentions “market volatility” or “recent earnings,” these keywords are identified. When the AI model detects relevant keywords, it recognizes that the conversation's focus has shifted from the initial topic of the investment portfolio to a new topic, such as market analysis or earnings reports. The instant solution engages a specialized GenAI model in response to the detected shift in focus. For example, if the user discusses market trends, a GenAI model trained in market analysis is activated. The GenAI model dynamically generates content based on the newly identified topic. This content may include market trend analysis, historical data, or specific stock information tailored to the user's queries and the detected keywords. The newly generated content is reflected on the user's dashboard. The dashboard is updated in real-time to display the relevant information prominently, ensuring that the advisor and the user have immediate access to the most pertinent data aligned with the ongoing conversation's focus. The financial advisor can effectively address the user's inquiries and concerns with the updated dashboard. The real-time adaptation of content ensures that the conversation remains productive and relevant to the user's current needs.

In one embodiment, as a user engages in a call with a financial advisor or relevant party, the instant solution continuously records the conversation and converts the audio into a text-based call transcript using a speech-to-text converter. The instant solution employs Natural Language Processing (NLP) techniques to analyze the call transcript. It identifies various topics discussed during the call. For example, these topics could include investment portfolio performance, market analysis, risk assessment, and more. After identifying these topics, the instant solution proceeds to execute an AI model for each of them. These AI models have been trained to understand and analyze specific areas, such as market trends, financial performance, or risk assessment. Based on the execution of these AI models, the instant solution ranks the identified topics in terms of their relevance and importance to the ongoing conversation. For instance, if the user's concerns about market volatility are dominant in the conversation, the topic of “market analysis” may receive a higher priority ranking. The instant solution then uses these priority rankings to dynamically adjust the content displayed on the dashboard. It ensures that the most relevant and important information about the highly ranked topics is readily available and featured.

For example, the user initiates a call with a financial advisor through the software application, indicating that they want to discuss their investment portfolio. The initial dashboard displays relevant user investment data, including asset allocation, performance metrics, and risk assessment. As the call progresses, the instant solution records the audio and converts it into a text-based call transcript using a speech-to-text converter. During this phase, the user discusses various aspects of their portfolio, including recent market developments. The instant solution leverages NLP techniques to analyze the call transcript and identifies multiple topics discussed during the conversation. These topics may include “investment portfolio performance,” “market analysis,” “risk assessment,” and the like. For each identified topic, the instant solution executes specific AI models trained to understand and analyze those areas. For instance, it executes a market analysis AI model to assess recent market trends and a risk assessment AI model to evaluate the portfolio's risk exposure. Based on the outputs of these AI models, the instant solution ranks the identified topics in terms of their current relevance and importance within the ongoing conversation. It recognizes that the user has expressed heightened concerns about market volatility. The instant solution dynamically adjusts the content displayed on the dashboard. It repositions and highlights market analysis-related data, including real-time market trends, historical market data, and volatility analysis. Simultaneously, it de-emphasizes less relevant content, such as long-term performance metrics. As the user continues the conversation and expresses specific questions or uncertainties about the market, the instant solution refines the real-time dashboard content. For example, it may display news articles related to recent market events and potential strategies for managing market volatility.

In one embodiment, the instant solution is configured to arrange the content to be displayed on the dashboard based on the ranked priorities of the plurality of topics. This means that once the instant solution has identified multiple topics discussed during a call, ranked them in terms of relevance, and adjusted the dashboard content accordingly (as described herein), it further optimizes the layout and presentation of this content. The instant solution prominently displays the most crucial information related to the highest-ranked topic. For instance, if market volatility is identified as the most relevant topic during a financial advisory call, the instant solution may position real-time market data, volatility analysis, and relevant news articles front and center on the dashboard. Simultaneously, it may shift less critical information, like long-term performance metrics, to less prominent positions. This arrangement ensures that the user and the financial advisor have immediate access to the information most pertinent to the ongoing conversation, enhancing the effectiveness of the call. It streamlines the user experience by minimizing the need for manual navigation or content searches, enabling the user to focus on the topics of highest interest and importance.

For example, a financial advisor initiates a call with a client to discuss their investment portfolio. The dashboard initially displays a variety of investment data, including asset allocation, performance metrics, and risk assessment, as these are the default topics of interest. As the conversation progresses, the client expresses concerns about the recent market volatility, using keywords like “market fluctuations” and “economic uncertainty.” The AI model detects this shift in focus based on keywords and sentiment analysis. Based on the AI model's prioritization, the instant solution identifies the new topic, “market volatility,” as the most relevant. It also identifies that the previous topics related to performance metrics are no longer the primary focus. The AI model dynamically generates content related to market trends, historical data, and strategies for managing a volatile market based on the execution of a GenAI model. The dashboard is updated to prominently display the newly generated content about market volatility, positioning it front and center. Simultaneously, it shifts the content related to performance metrics to a less prominent location. With the dashboard content now aligned with the client's immediate concerns, the financial advisor can effectively address the client's worries about market volatility. The client does not need to navigate through the dashboard to find relevant information; it is already presented prominently.

In one embodiment, the instant solution is designed to support the actions of a financial advisor conducting a call with a client. Initially, the dashboard displays content related to the main topic of interest: the client's overall investment portfolio. This content includes asset allocation, performance metrics, and risk assessment, as these are typically the primary concerns for investment discussions. However, as the conversation progresses, the AI model identifies a sub-topic of interest based on keywords and sentiment analysis. For example, the client might express particular interest in socially responsible investments (SRI) and environmental, social, and governance (ESG) criteria. The instant solution detects this shift in focus and recognizes SRI/ESG as the sub-topic of interest. To accommodate this shift, the instant solution dynamically generates content related to SRI/ESG investments and displays it on the dashboard. This new content takes a more prominent position, ensuring that the advisor can effectively address the client's specific interest. Simultaneously, the content related to the overall portfolio retains its presence but in a less prominent location. This arrangement allows the financial advisor to maintain a balance between addressing the main topic (the overall investment portfolio) and the sub-topic of interest (SRI/ESG investments), ensuring a comprehensive and customized discussion tailored to the client's priorities.

For example, the financial advisor initiates a call with a client using a communication platform integrated with the instant solution. The main topic of the call is set to discuss the client's investment portfolio. The instant solution generates an initial dashboard on the advisor's user device. The dashboard prominently displays content related to the client's overall investment portfolio, including asset allocation, performance metrics, and risk assessment. As the conversation progresses, the client expresses a growing interest in SRI and ESG criteria. Keywords like “SRI,” “ESG,” and “sustainable investments” trigger this shift in focus. The AI model integrated into the instant solution analyzes the conversation discussion data in real-time and identifies that the sub-topic of interest has shifted to SRI/ESG investments based on keyword recognition and sentiment analysis. In response to the detected shift in focus, the AI model dynamically generates content related to SRI/ESG investments. This content includes information on sustainable investment options, ESG ratings, and relevant investment strategies. The instant solution updates the dashboard displayed on the advisor's user device. The newly generated content related to SRI/ESG investments now occupies a more prominent position on the dashboard, ensuring it captures the advisor's attention. During the call, the financial advisor can now seamlessly address both the main topic (the client's overall investment portfolio) and the sub-topic of interest (SRI/ESG investments). The advisor can provide customized advice and recommendations to align with the client's priorities.

In one embodiment, the financial advisor initiates a call with a client using a communication platform integrated with the instant solution. The main topic of the call is set to discuss the client's investment portfolio. The instant solution generates an initial dashboard on the advisor's user device. The dashboard prominently displays content related to the client's overall investment portfolio, including asset allocation, performance metrics, and risk assessment. As the conversation progresses, the client expresses a growing interest in SRI and ESG criteria. Keywords like “SRI,” “ESG,” and “sustainable investments” trigger this shift in focus. The AI model integrated into the instant solution analyzes the conversation discussion data in real-time. It identifies that the sub-topic of interest has shifted to SRI/ESG investments based on keyword recognition and sentiment analysis. In response to the detected shift in focus, the AI model dynamically generates content related to SRI/ESG investments. This content includes information on sustainable investment options, ESG ratings, and relevant investment strategies. The instant solution updates the dashboard displayed on the advisor's user device. The newly generated content related to SRI/ESG investments now occupies a more prominent position on the dashboard, ensuring it captures the advisor's attention. During the call, the financial advisor can now seamlessly address both the main topic (the client's overall investment portfolio) and the sub-topic of interest (SRI/ESG investments). The advisor can provide customized advice and recommendations to align with the client's priorities.

For example, in this embodiment, the instant solution enhances the user's experience by utilizing their browsing history to identify another topic of interest during a call. As the user initiates a call or during an ongoing call, the instant solution accesses the user's browsing history through their connected device. The browsing history may include a record of websites, searches, and online activities. The instant solution employs natural language processing (NLP) techniques to extract relevant keywords and phrases from the user's browsing history. These keywords serve as indicators of the user's recent interests and preferences. Based on the extracted keywords, the instant solution identifies another topic of interest that aligns with the user's recent online activities. For example, if the user has been researching real estate investment opportunities, keywords like “real estate trends,” “property listings,” or “rental income” could indicate an interest in real estate investments. Once the additional topic of interest is identified, the AI model within the instant solution dynamically generates content related to this new topic. The instant solution then adjusts the dashboard content to include information, statistics, or insights relevant to the newly identified topic. The updated dashboard enables the user and the conversation partner to engage in a more relevant and meaningful discussion. The user benefits from personalized content that aligns with their current interests, enhancing the overall call experience.

In one embodiment, the process begins when a user initiates a call on a communication platform integrated with the instant solution designed to facilitate productive discussions across various topics. As the call starts, the instant solution retrieves the user's browsing history from their connected device. This browsing history contains a record of the user's recent online activities, including searches, visited websites, and viewed content. The instant solution employs advanced NLP and machine learning techniques to analyze the user's browsing history. It identifies specific keywords, phrases, and patterns that indicate the user's areas of interest and recent online activities. For example, if the user has been researching topics related to technology stocks, the instant solution recognizes keywords like “tech companies,” “stock market news,” and “latest tech trends.” The instant solution dynamically generates content relevant to the identified topic based on the extracted keywords and detected topics of interest from the browsing history. This content may include real-time stock market updates, news articles about technology companies, and financial analysis reports. Simultaneously, the instant solution adjusts the user's dashboard in real-time to prominently display this newly generated content. The dashboard becomes a personalized and tailored interface that provides the user with immediate access to information aligned with their interests. For example, the dashboard may showcase real-time stock prices of technology companies, news headlines in the technology sector, and recommended investment opportunities in technology stocks. As the user engages in the call, the content displayed on the dashboard becomes a focal point of discussion. The financial advisor or call participant can use this content to guide the conversation, offer insights, answer questions, and provide recommendations that are directly relevant to the user's recent online activities. The current embodiment enables the instant solution to leverage a user's browsing history to dynamically generate and present content that supports the user's current topic of interest during a call. This ensures that the conversation remains highly relevant and productive, enhancing the overall user experience and delivering valuable insights tailored to the user's preferences and online behaviors.

For example, the user initiates a call on a communication platform integrated with the instant solution, expressing a desire to discuss investment opportunities in the technology sector. The instant solution, connected to the user's device, retrieves the user's browsing history, which includes recent online activities related to technology stocks and companies. The instant solution employs natural language processing and machine learning algorithms to analyze the user's browsing history. It identifies keywords and patterns indicating the user's interest in technology stocks, such as “tech companies,” “stock market news,” and “recent tech IPOs.” Based on the browsing history analysis, the instant solution identifies “technology stocks” as the primary topic of interest for the user during this call. Leveraging this topic identification, the instant solution dynamically generates content related to technology stocks. This content includes real-time stock prices of major technology companies, news articles about recent developments in the technology sector, and financial analysis reports specific to technology stocks. Simultaneously, the instant solution adjusts the user's dashboard interface in real-time. It replaces the default dashboard content with the newly generated content related to technology stocks. The dashboard now prominently displays the real-time stock prices, current technology news, and investment recommendations. During the call, as the user and the financial advisor engage in a conversation about technology investments, the content displayed on the dashboard becomes a central point of discussion. The financial advisor can refer to real-time stock prices, share insights about recent technology company performance, and provide investment strategies based on the content presented. The user actively engages with the content on the dashboard, asking questions about specific technology companies, seeking recommendations, and discussing recent news articles. The conversation remains highly relevant to the user's interests. The financial advisor leverages the dynamically generated content to offer personalized insights and recommendations tailored to the user's browsing history and current topic of interest, enhancing the value of the conversation.

The above embodiments may be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

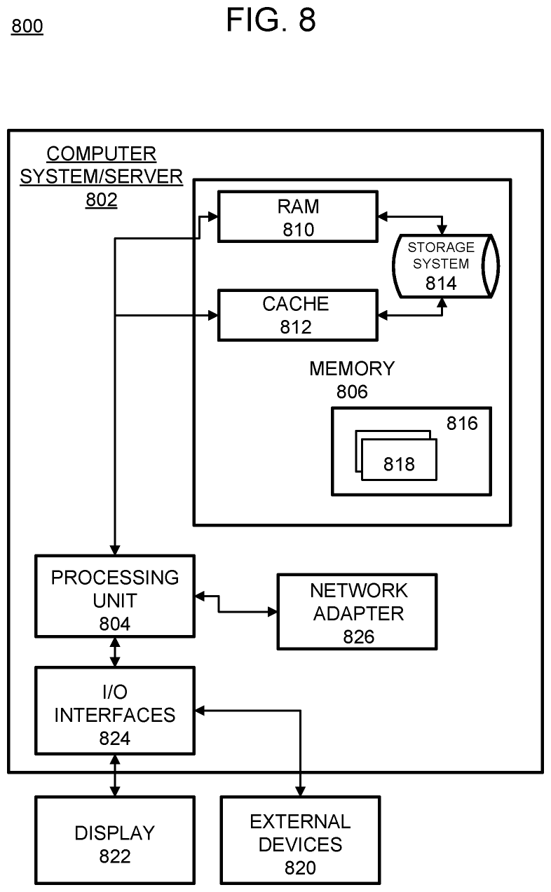

An exemplary storage medium may be coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates an example system 800 that supports one or more of the example embodiments described and/or depicted herein. The system 800 comprises a computer system/server 802, which is operational with numerous other general purpose or special purpose computing system environments or configurations. Examples of well-known computing systems, environments, and/or configurations that may be suitable for use with computer system/server 802 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 802 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 802 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 802 in the example system 800 is shown in the form of a general-purpose computing device. The components of computer system/server 802 may include, but are not limited to, one or more processors or processing units (processor 804), a system memory 806, and a bus that couples various system components including the system memory 806 to the processor 804.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 802 typically includes a variety of computer system readable media. Such media may be any available media that is accessible by computer system/server 802, and it includes both volatile and non-volatile media, removable and non-removable media. The system memory 806, in one embodiment, implements the flow diagrams of the other figures.

The system memory 806 can include computer system readable media in the form of volatile memory, such as RAM 810 and/or cache memory 812. Computer system/server 802 may further include other removable/non-removable, volatile/non-volatile computer system storage media. By way of example only, storage system 814 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, the system memory 806 may include at least one program product having a set (e.g., at least one) of program modules that are configured to carry out the functions of various embodiments of the application.

Program/utility 816, having a set (at least one) of program modules 818, may be stored in the system memory 806 by way of example, and not limitation, as well as an operating system, one or more application programs, other program modules, and program data. Each of the operating system, one or more application programs, other program modules, and program data or some combination thereof, may include an implementation of a networking environment. Program modules 818 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 802 may also communicate with one or more external devices 820 such as a keyboard, a pointing device, a display 822, etc.; one or more devices that enable a user to interact with computer system/server 802; and/or any devices (e.g., network card, modem, etc.) that enable computer system/server 802 to communicate with one or more other computing devices. Such communication can occur via input/output (I/O) interfaces 824. Still yet, computer system/server 802 can communicate with one or more networks such as a local area network (LAN), a general wide area network (WAN), and/or a public network (e.g., the Internet) via network adapter 826. As depicted, network adapter 826 communicates with the other components of computer system/server 802 via a bus. It should be understood that although not shown, other hardware and/or software components could be used in conjunction with computer system/server 802. Examples include, but are not limited to, microcode, device drivers, redundant processing units, external disk drive arrays, redundant array of independent disks (RAID) systems, tape drives, and data archival storage systems, etc.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a memory; and
a processor communicatively coupled to the memory, the processor configured to:
identify a first topic from a call actively in progress,
display a dashboard on a user device on the call, wherein the dashboard comprises content related to the first topic,
receive discussion data from the call,
determine that a focus of the call has shifted from the first topic to a second topic,
execute an artificial intelligence (AI) model on the second topic;
dynamically generate dashboard content based on the execution, and
display the dynamically generated dashboard content to the dashboard on the user device.

2. The apparatus of claim 1, wherein the processor is configured to receive audio from the call while the call is in progress, convert the audio into text based on execution of a speech-to-text converter, and determine the focus of the call has shifted based on keywords identified within the text.

3. The apparatus of claim 1, wherein the processor is configured to identify a plurality of topics from a meeting summary stored in a software application and compare keywords in the received discussion data to keywords in the meeting summary.

4. The apparatus of claim 1, wherein the processor is configured to move the content of the first topic from its initial location to a different location on the dashboard and present content of the second topic on the dashboard at the initial location of the content of the first topic.

5. The apparatus of claim 1, wherein the processor is configured to dynamically instantiate new content that corresponds to the second topic on the dashboard at a different location than the content of the first topic on the dashboard.

6. The apparatus of claim 1, wherein the processor is configured to identify a plurality of topics of interest to be discussed on the call and display a plurality of modules of content for the plurality of topics of interest, respectively, on the dashboard simultaneously.

7. The apparatus of claim 6, wherein the processor is configured to rearrange the plurality of modules of content for the plurality of topics of interest based on the execution of the AI model on the second topic.

8. A method comprising:
identifying a first topic from a call actively in progress;
displaying a dashboard on a user device on the call, wherein the dashboard comprises content related to the first topic;
receiving discussion data from the call;
determining that a focus of the call has shifted from the first topic to a second topic;
executing an artificial intelligence (AI) model on the second topic;
dynamically generating dashboard content based on the execution; and
displaying the dynamically generated dashboard content to the dashboard on the user device.

9. The method of claim 8, wherein the receiving comprises receiving audio from the call while the call is in progress, converting the audio into text based on execution of a speech-to-text converter, and determining the focus of the call has shifted based on keywords identified within the text.

10. The method of claim 8, wherein the identifying comprises identifying a plurality of topics from a meeting summary stored in a software application, and the determining comprises comparing keywords in the received discussion data to keywords in the meeting summary.

11. The method of claim 8, wherein the dynamically generating comprises dynamically moving the content of the first topic from its initial location to a different location on the dashboard and presenting content of the second topic on the dashboard at the initial location of the content of the first topic.

12. The method of claim 8, wherein the dynamically generating comprises dynamically instantiating new content corresponding to the second topic on the dashboard at a different location than the content of the first topic on the dashboard.

13. The method of claim 8, wherein the identifying comprises identifying a plurality of topics of interest to be discussed during the call and the displaying the dashboard comprises displaying a plurality of modules of content for the plurality of topics of interest, respectively, on the dashboard simultaneously.

14. The method of claim 13, wherein the dynamically generating comprises rearranging the plurality of modules of content for the plurality of topics of interest based on the execution of the AI model on the second topic.

15. A computer-readable storage medium comprising instructions stored therein which when executed by a processor cause the processor to perform:
identifying a first topic from a call actively in progress;
displaying a dashboard on a user device on the call, wherein the dashboard comprises content related to the first topic;
receiving discussion data from the call;
determining that a focus of the call has shifted from the first topic to a second topic;
executing an artificial intelligence (AI) model on the second topic;
dynamically generating dashboard content based on the execution; and
displaying the dynamically generated dashboard content to the dashboard on the user device.

16. The computer-readable storage medium of claim 15, wherein the receiving comprises receiving audio from the call while the call is in progress, converting the audio into text based on execution of a speech-to-text converter, and determining the focus of the call has shifted based on keywords identified within the text.

17. The computer-readable storage medium of claim 15, wherein the identifying comprises identifying a plurality of topics from a meeting summary stored in a software application, and the determining comprises comparing keywords in the received discussion data to keywords in the meeting summary.

18. The computer-readable storage medium of claim 15, wherein the dynamically generating comprises dynamically moving the content of the first topic from its initial location to a different location on the dashboard and presenting content of the second topic on the dashboard at the initial location of the content of the first topic.

19. The computer-readable storage medium of claim 15, wherein the dynamically generating comprises dynamically instantiating new content corresponding to the second topic on the dashboard at a different location than the content of the first topic on the dashboard.

20. The computer-readable storage medium of claim 15, wherein the identifying comprises identifying a plurality of topics of interest to be discussed during the call and the displaying the dashboard comprises displaying a plurality of modules of content for the plurality of topics of interest, respectively, on the dashboard simultaneously.
